(19) United States
(12) Patent Application Publication
(10) Pub. No.: US 2026/0219960 A1
(43) Pub. Date: Jul. 30, 2026

(54) OFFLOAD SERVER, OFFLOAD CONTROL METHOD AND OFFLOAD PROGRAM

(71) Applicant: NIPPON TELEGRAPH AND TELEPHONE CORPORATION, Tokyo (JP)

(72) Inventor: Yoji YAMATO, Tokyo (JP)

(73) Assignee: NIPPON TELEGRAPH AND TELEPHONE CORPORATION, Tokyo (JP)

(21) Appl. No.: 19/145,510

(22) PCT Filed: Jan. 6, 2023
(86) PCT No.: PCT/JP2023/000217

§ 371 Date: Jul. 3, 2025

(51) Int. Cl. G06F 9/50; G06F 11/34

(52) U.S. Cl. CPC G06F 9/5083; G06F 9/505; G06F 11/3433

(57) ABSTRACT

An offload server includes: a request processing load analysis section that analyzes a request processing load resulting from processing data used by a user with a current offload pattern; a representative data selection section that identifies an application whose request processing load is analyzed as high and selects representative data from request data at a time of use of the application; an improvement level calculation section that creates a new offload pattern based on the selected representative data and calculates a performance improvement effect by comparing a processing time and a use frequency of the created new offload pattern with a processing time and a use frequency of the current offload pattern; and a reconfiguration suggestion section that suggests a GPU reconfiguration when the performance improvement effect is equal to or more than a predetermined threshold.

### CROSS-REFERENCE TO RELATED APPLICATION

This is a National Stage Application of PCT Application No. PCT/JP2023/000217, filed on Jan. 6, 2023. The disclosure of the prior application is considered part of the disclosure of this application, and is incorporated in its entirety into this application.

### BACKGROUND

### Technical Field

The present invention relates to an offload server, an offload control method, and an offload program for automatically offloading function processing to a Graphics Processing Unit (GPU) or the like.

### Background Art

Heterogeneous computational resources, other than Central Processing Units (CPUs), are increasingly used. For example, image processing has begun to be performed on servers that use an enhanced GPU (accelerator) and signal processing has begun to be accelerated by an FPGA (accelerator). An FPGA is a programmable gate array that can be configured by a person such as a designer after manufacture and is a type of Programmable Logic Device (PLD). Amazon Web Services (AWS) (registered trademark) provides GPU instances and FPGA instances and these resources can be used on-demand as well. Microsoft (registered trademark) is using FPGAs to increase search efficiency.

In an OpenIoT (Internet of Things) environment, a wide variety of applications are expected to be created using service coordination techniques and the like, and operational applications are expected to be improved in performance by exploiting further advanced hardware. To that end, however, programming and settings adapted to the hardware to be operated are required. For example, a lot of technical knowledge regarding techniques such as Compute Unified Device Architecture (CUDA) and Open Computing Language (OpenCL) is required, making the programming and settings challenging. OpenCL is an open Application Programming Interface (API) that can uniformly handle any computational resources (not limited to CPUs and GPUs) without being bound to specific hardware.

In order to allow GPUs and FPGAs to be readily used in user's IoT applications, the following is required: when deploying a general application such as an image processing or cryptographic processing application to run in an OpenIoT environment, it is desirable that an OpenIoT platform analyze application logics and automatically offloads processing to a GPU/FPGA.

CUDA, which is a development environment for GPGPU (General Purpose GPU) which uses computational capability of a GPU for other processing in addition to image processing, are evolving. CUDA is a development environment for GPGPUs. Further, OpenCL has emerged as a standard for uniformly handling heterogeneous hardware such as GPUs, FPGAs, and many-core CPUs.

In CUDA and OpenCL, programming is performed using extensions of the C programming language. However, the difficulty of such programming is high because it requires describing memory-to-memory copy/release operations between a CPU and devices like GPUs. In fact, not many engineers can make full use of CUDA and OpenCL.

There is known a technique in which, for the purpose of performing processing using a GPGPU simply, portions to be processed in parallel, such as loop statements, are designated in a directive-based language and a compiler compiles them into device-specific code in accordance with the directives. Technical specifications include Open Accelerator (OpenACC) and the like and compilers include PGI Compiler (registered trademark) and the like. In an example using OpenACC, a user specifies, in a code written in C/C++/Fortran language, an OpenACC directive to cause parallel processing to be performed. The PGI Compiler checks the parallelizability of the code, generates execution binaries for GPU and CPU, and converts them to execution modules. IBM JDK (registered trademark) supports a function of offloading designation of parallel processing in accordance with the lambda format of Java (registered trademark) to a GPU. Using these techniques, programmers need not be aware of, for example, data allocation to GPU memory.

In this way, offload processing to a GPU or an FPGA has been enabled by techniques such as OpenCL, CUDA and OpenACC.

However, while offload processing has been enabled, there are many problems to be addressed for appropriate offloading. For example, there are compilers with automatic parallelization functions. Such compilers includes Intel compiler (registered trademark). For automatic parallelization, parallel processing portions, such as for statements (iteration statements), in a program are extracted. However, when parallel processing is performed using a GPU, it is often unable to achieve good performance due to data exchange overhead between a CPU memory and a GPU memory. To accelerate by using a GPU, a skilled person has to perform tuning in OpenCL or CUDA and to search for appropriate parallel processing portions by using PGI Compiler or the like.

For this reason, it is difficult for an unskilled user to improve the performance of an application by using a GPU. In addition, even when using an automatic parallelization technique, much time is taken for trial-and-error tuning to determine whether to parallelize for statements or not before starting use of the application.

Examples of attempts to automate trial-and-error on parallel processing portions include Non-Patent Literatures 1 and 2. Non-Patent Literatures 1 and 2 attempt to appropriately extract loop statements suitable for offloading to a GPU by repeating performance measurements in a verification environment using an evolutionary computation technique and to collectively perform a transfer of variables between a CPU and a GPU in nested loop statements at an outermost possible loop, to achieve automatic acceleration.

In the cases of FPGA, as it takes a long time to perform compilation so that is it not possible to perform a measurement many times, there has been proposed a method such that candidate loop statements are narrowed down and translated according to OpenCL based on a loop statement arithmetic intensity and an FPGA resource usage rate at the time of offloading, and then a measurement is performed, to search for an appropriate pattern (Non-Patent Literature 2).

As for GPU offloading of loop statement, there has been proposed offloading using a genetic algorithm (GA), which is an evolutionary computation technique, as an approach for automating searching for a loop statement portions to be processed by a GPU (Non-Patent Literature 3).

### CITATION LIST

### Non-Patent Literature

Non-Patent Literature 1: Y. Yamato, T. Demizu, H. Noguchi and M. Kataoka, “Automatic GPU Offloading Technology for Open IoT Environment,” IEEE Internet of Things Journal, September 2018.
Non-Patent Literature 2: Y. Yamato, “Study of parallel processing area extraction and data transfer number reduction for automatic GPU offloading of IoT applications,” Journal of Intelligent Information Systems, Springer, DOI: 10.1007/s10844-019-00575-8, August 2019.
Non-Patent Literature 3: Y. Yamato, “Study and Evaluation of Improved Automatic GPU Offloading Method”, International Journal of Parallel, Emergent and Distributed Systems, Taylor and Francis, DOI: 10.1080/17445760.2021.1941010, June 2021.

### SUMMARY OF THE INVENTION

### Problems to be Solved by the Invention

In the conventional art, offloading to heterogeneous hardware is mainly performed manually, and automatic offloading methods are limited to the techniques described in Non-Patent Literatures 1 and 2.

In Non-Patent Literatures 1 to 3, GPU and FPGA automatic offloading methods for loop statements and the like are verified for the concept of environment adaptive software.

However, the automatic offloading methods described in Non-Patent Literatures 1 to 3 are based on the premise that adaptive processing such as conversion and deployment is performed before the start of the operation of the application, and it is not assumed that reconfiguration is to be performed based on a change or the like in the use characteristic after the start of the operation. That is, all of Non-Patent Literatures 1 to 3 are technologies for before the start of the operation of the application, and reconfiguration after the start of the operation has not been studied.

For example, in some cases, before the start of the operation, the logic is set so as to perform GPU processing on the premise that there are many processes having many classifications in image processing, but the number of object detection processes has increased in the image processing in the actual number of requests three months after the start of the operation, and thus it is better to change the logic for performing the GPU processing.

As described above, there is a problem that reconfiguration based on a change or the like in the use characteristic after the start of operation is not assumed.

The present invention has been made in view of such a point, and it is an object of the present invention to improve the efficiency of resource use in a GPU or the like having a limited resource amount by reconfiguring to a more appropriate logic based on the use characteristics not only before the start of operation but also after the start of operation.

### Means for Solving the Problem

To solve the problem described above, provided is an offload server that offloads specific processing of application specific processing to a Graphics Processing Unit (GPU), the offload server implemented on one or more processors and including: a processing load analysis section configured to analyze a request processing load resulting from processing data used by a user with a current offload pattern; a representative data selection section configured to identify an application whose request processing load is analyzed as high by the processing load analysis section and select representative data from request data at a time of use of the application; an improvement level calculation section configured to create a new offload pattern based on the representative data selected by the representative data selection section and calculate a performance improvement effect by comparing a processing time and a use frequency of the created new offload pattern with a processing time and a use frequency of the current offload pattern; and a reconfiguration suggestion section configured to suggest a GPU reconfiguration when the performance improvement effect is equal to or more than a predetermined threshold.

### Advantageous Effects of Invention

According to the present invention, it is possible to perform reconfiguration to a more appropriate logic based on the use characteristics after the start of operation, and it is possible to improve the efficiency of resource use in a GPU or the like in which the resource amount is limited.

### BRIEF DESCRIPTION OF THE DRAWINGS

FIG. 1 is a diagram illustrating an environment adaptive software system including an offload server according to an embodiment of the present invention.

FIG. 2 is a function block diagram illustrating an exemplary configuration of the offload server according to the embodiment.

FIG. 3 is a diagram illustrating automatic offload processing of the offload server according to the embodiment.

FIG. 4 is a diagram illustrating a concept of a search process by a control section (automatic offloading function section) using Simple GA of the offload server according to the embodiment.

FIG. 5 is a diagram illustrating an example of a conventional CPU program in a comparative example.

FIG. 6 is a diagram illustrating example loop statements in a case where data is transferred from a CPU to a GPU using a simple CPU program in a comparative example.

FIG. 7 is a diagram illustrating example loop statements in a case where data is transferred from a CPU to a GPU by the offload server according to the embodiment and nest batching is used.

FIG. 8 is a diagram illustrating example loop statements in a case where data is transferred from a CPU to a GPU by the offload server employing collective transfers according to the embodiment.

FIG. 9 is a diagram illustrating example loop statements in a case where data is transferred from the CPU to the GPU by the offload server employing collective transfers and using a temporary area according to the embodiment.

FIG. 10A is a flowchart for explaining an overview of operation of an implementation of the offload server according to the embodiment.

FIG. 10B is a flowchart for explaining an overview of operation of an implementation of the offload server according to the embodiment.

FIG. 11 is a flowchart illustrating reconfiguration after the start of operation of the offload server according to the embodiment.

FIG. 12 is a detailed flowchart of commercial request data history analysis processing of the offload server according to the embodiment.

FIG. 13 is a detailed flowchart of improvement level calculation processing of the offload server according to the embodiment.

FIG. 14 is a hardware configuration diagram illustrating an example of a computer that implements functions of the offload server according to the embodiment.

### MODES FOR CARRYING OUT THE INVENTION

An offload server 1 and the like in a mode for carrying out the present invention (hereinafter referred to as “present embodiment”) will now be described.

### DESCRIPTION OF BACKGROUND

There are a wide variety of applications that one may desire to offload. Moreover, in applications involving a large amount of computation and consuming computation time, such as image analysis for video processing and machine learning processing for analyzing sensor data, a lot of time is spent on repetitive processing with loop statements. Therefore, it is conceivable to automatically offload loop statements to a GPU for acceleration.

There are the following fundamental problems with automatic offloading of loop statements to a GPU: Even if a compiler is possibly able to find the restriction like “this loop statement cannot be processed in parallel processing with a GPU”, it is difficult at present for the compiler to find appropriateness like “this loop statement is appropriate for parallel processing with a GPU”. In addition, it is considered that, in general, loop statements with higher computation density, such as a loop statement with many loop iterations, are more appropriate for automatic offloading to a GPU. However, it is difficult to predict how much performance improvement can be achieved, without actual measurement. For these reasons, conventionally, instructions to offload loop statements to a GPU are manually provided and performance measurement is performed in a trial and error fashion.

In light of the above-described problems, Non-Patent Literature 1 proposes to, using a Genetic Algorithm (GA), automatically detect appropriate loop statements to be offloaded to a GPU. In particular, Non-Patent Literature 1 proposes to: first check a general program, which is not intended to be parallelized, for parallelizable loop statements; then represent the parallelizable loop statements as a gene by assigning a value of 1 to each loop statement to be executed on a GPU and assigning a value of 0 to each loop statement to be executed on a CPU; and then repeat a performance verification trial in a verification environment to search for appropriate areas. By narrowing down to parallelizable loop statements and retaining and recombining accelerable parallel processing patterns in the form of portions of genes, a pattern that can be efficiently accelerated can be searched for from among a huge number of possible parallel processing patterns.

In the case of Non-Patent Literature 1, variables used in nested loop statements are transferred between a CPU and a GPU when the loop statements are offloaded to the GPU. However, when a transfer is performed between the CPU and the GPU at a low nesting level, transfer is performed in each iteration of the low-level loop, which is not efficient.

Non-Patent Literature 2 proposes that variables that can be transferred between a CPU and a GPU at a high nesting level without problem be collectively transferred at the high nesting level. This approach has a certain effect on acceleration by reduction in the number of transfers because loops with many loop iterations, which take long processing time, are often nested.

In the cases of Non-Patent Literatures 1 and 2, automatic acceleration of even medium-size applications that include more than 100 loop statements have been actually observed. In consideration of practicality, acceleration is more required.

In Non-Patent Literature 3, based on Non-Patent Literatures 1 and 2, more practical improvements such as further reduction of CPU-GPU transfers and expansion of loop types for which GPU processing can be designated are confirmed.

### (Basic Concept)

A basic concept of the present invention will be described.

First, environment adaptive software will be described.

### [Environment Adaptive Software]

The environment adaptive software executed by an offload server of the present invention has the following features. That is, the offload server automatically performs conversion, resource setting, determination of deployment, and the like so that a program code once described can use a GPU, an FPGA, a multi-core CPU, and the like existing in the environment of a deployment destination by execution of the environment adaptive software, and operates the application with high performance. As elements of the environment adaptive software, there are a method of automatically offloading a loop statement of a code and a function block to a GPU and an FPGA, and a method of appropriately assigning a processing resource amount of the GPU and the like.

In the case of GPU, loop statements that can be GPU-processed are combined by GA, and measurement on a scale of 1000 times is performed to search for an optimal pattern. In the case of FPGA, as it takes six hours or more for one compilation, when offloading loop statements, the loop statements are narrowed down to loop statements having high arithmetic intensities and a large number of loop iterations and thus having high resource efficiencies, and an offload pattern with those loop statements is created and measured to search for high-speed pattern.

[Reconfiguration after Starting Operation of Application]

Reconfiguration after the start of the operation of an application will be described.

The automatic offloading methods described in Non-Patent Literatures 1 and 2 are premised on the assumption that adaptive processing such as conversion and deployment is performed before the start of the operation of an application.

Incidentally, in an operation in which a GPU is used for acceleration of an application server, excluding special use cases such as reconfiguration of a circuitry of an artificial satellite, there is no example where a GPU logic is reconfigured based on the use characteristics during operation of an application (“during operation” is a form of “after starting operation”) even when looking over commercial clouds (GPU instance of Amazon Web Services (AWS) (registered trademark) or the like). This is because reconfiguring a GPU logic during operation is challenging.

The present invention reconfigures the GPU offload logic (hereinafter, GPU logic) based on a change or the like in the use characteristic after the start of the operation of an application. For example, the GPU logic is reconfigured based on the use characteristic during operation.

According to the present invention, first, the operation is started while offloading a normal program for a CPU to a GPU (<adaptive processing such as conversion and deployment before start of operation>).

Next, request characteristics are analyzed, and the GPU logic is changed to another program (<reconfiguration after start of operation>).

### Embodiment

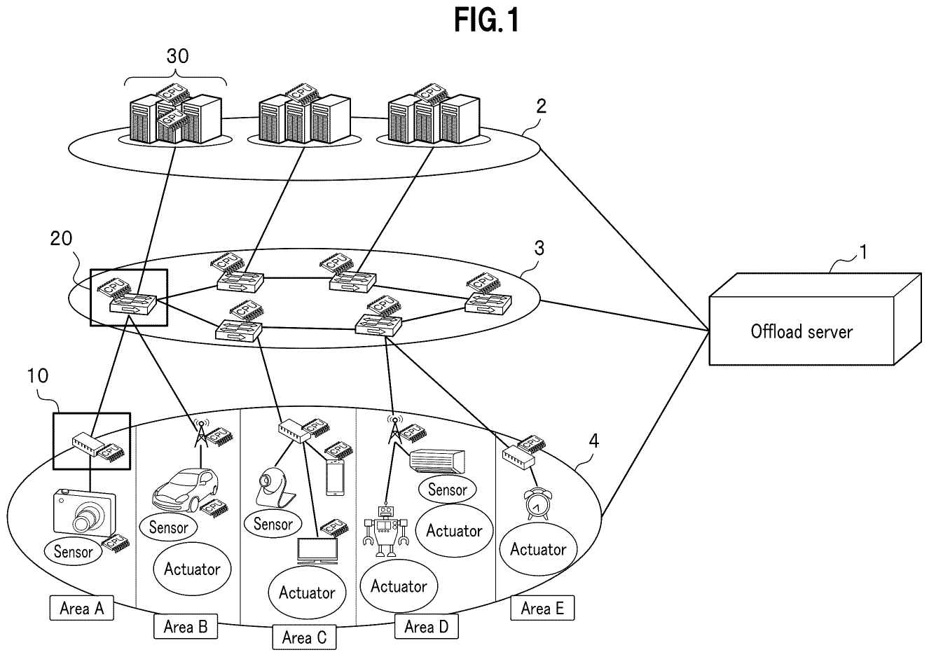

FIG. 1 is a diagram illustrating an environment adaptive software system including an offload server 1 according to the present embodiment.

The environment adaptive software system according to the present embodiment is characterized by including the offload server 1 in addition to the configuration of a conventional environment adaptive software. The offload server 1 is an offload server that offloads specific processing of an application to an accelerator. Further, the offload server 1 is communicatively connected to devices located in three layers, namely, a cloud layer 2, a network layer 3 and a device layer 4. Data centers 30 are deployed in the cloud layer 2, network edges 20 are deployed in the network layer 3, and gateways 10 are deployed in the device layer 4.

The environment adaptive software system including the offload server 1 according to the present embodiment achieves efficiency enhancement by appropriately performing function deployment and processing offloading in each of the device layer 4, the network layer 3, and the cloud layer 2. The environment adaptive software system achieves, primarily: function deployment efficiency enhancement for deploying functions in appropriate places in three layers to perform processes; and efficiency enhancement by offloading the function processing, such as image analysis, to heterogeneous hardware, such as GPUs and FPGAs.

Hereinafter, a description will be given of an exemplary configuration in which the offload server 1 according to the present embodiment performs offload processing in the background while services for users are being used in the environment adaptive software system.

When providing a service, it is conceivable to provide the service to the user as a trial on the first day and perform offload processing of image analysis or the like in the background of the service and, and on the succeeding days, provide the service with a reasonable price by offloading the image analysis to a GPU.

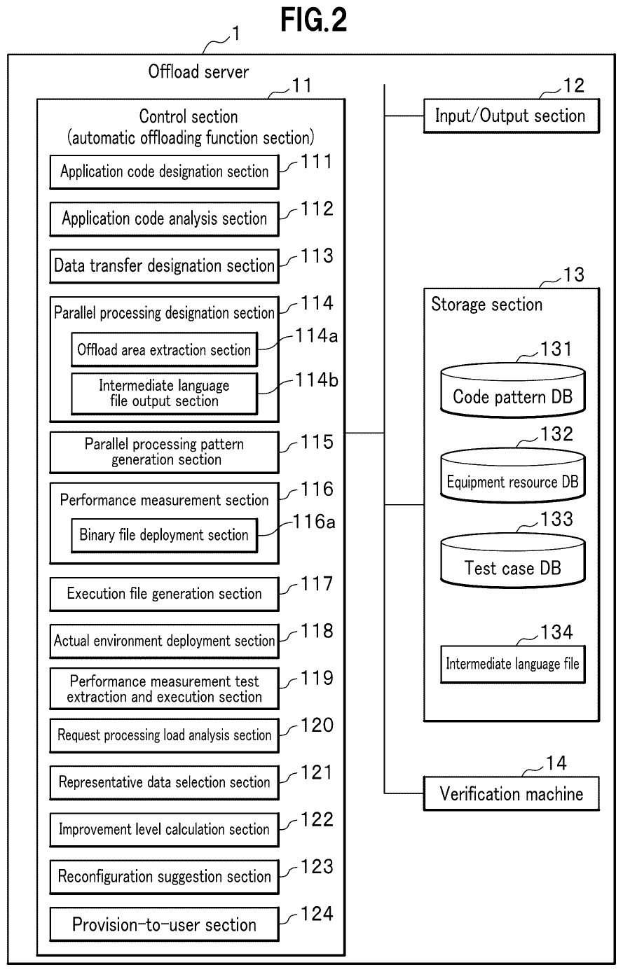

FIG. 2 is a function block diagram illustrating an exemplary configuration of the offload server 1 according to the embodiment of the present invention.

The offload server 1 is a device that executes environment adaptive software processing. As a form of the environment adaptive software, the offload server 1 automatically offloads specific processing of an application to an accelerator (<automatic offloading>).

Furthermore, the offload server 1 can be connected to an emulator.

As illustrated in FIG. 2, the offload server 1 includes a control section 11, an input/output section 12, a storage section 13, and a verification machine 14 (accelerator verification device).

The control section 11 controls the entire offload server 1, performs reconfiguration control after the start of the operation of the application, and activates another OpenACC in a commercial environment to perform reconfiguration (described later). Furthermore, the control section 11, with another server (not illustrated) that processes OpenACC after GPU reconfiguration, at the time of executing GPU reconfiguration, stops OpenACC before reconfiguration, newly starts the other server, and switches routing to the other server for a new request.

The input/output section 12 includes a communication interface for transmitting and receiving information to and from devices and an input/output interface for sending and receiving information to and from input devices such as a touch panel or a keyboard and output devices such as a monitor.

The storage section 13 includes a hard disk, a flash memory, a Random Access Memory (RAM) and the like.

The storage section 13 stores a code pattern DB 131, an equipment resource DB 132, a test case database (DB) 133 and temporarily stores programs (offload programs) for executing functions of the control section 11 and information (e.g., an intermediate language file (intermediate file) 134) required for processing of the control section 11.

The test case DB 133 stores performance test items. The test case DB 133 stores information for performing a test for measuring the performance of an application to be accelerated. For example, in the case of a deep learning application for image analysis processing, sample images and test items for testing execution of the image analysis processing.

The verification machine 14 includes, as a verification environment for environment adaptive software, a Central Processing Unit (CPU), a GPU, and an FPGA (accelerator).

Note that, in FIG. 2, although the offload server 1 includes the verification machine 14, the verification machine 14 may be provided outside the offload server 1.

The control section 11 is an automatic offloading function section that is responsible for controlling the entire offload server 1. The control section 11 is embodied by a not-illustrated CPU loading a program (offload program) stored in the storage section 13 into the RAM and executing it, for example.

The control section 11 includes an application code designation section 111 (configured to designate application code), an application code analysis section 112 (configured to analyze application code), a data transfer designation section 113, a parallel processing designation section 114, a parallel processing pattern generation section 115, a performance measurement section 116, an execution file generation section 117, an actual environment deployment section 118 (configured to deploy final binary files to actual environment) a performance measurement test extraction and execution section 119 (configured to extract performance test cases and run automatically), and a request processing load analysis section 120 (processing load analysis section), a representative data selection section 121, an improvement level calculation section 122, a reconfiguration suggestion section 123, and a provision-to-user section (provide price and performance to a user to judge) 124.

### <Application Code Designation Section 111>

The application code designation section 111 designates the input application code. Specifically, the application code designation section 111 identifies the processing function (such as image analysis) of the service being provided to a user.

### <Application Code Analysis Section 112>

The application code analysis section 112 analyzes the source code of the processing function to identify structures such as loop statements and calls to an FFT library.

### <Data Transfer Designation Section 113>

The data transfer designation section 113 analyzes reference relationships of variables used in loop statements of an application and designates, for data that can be transferred outside a loop, a data transfer using an explicit directive (#pragma acc data copyin/copyout/copy(a[ . . . ]), where a is a variable) that explicitly specifies a data transfer outside the loop.

The data transfer designation section 113 performs data transfer designation using an explicit directive (#pragma acc data copyin(a[ . . . ])) that explicitly specifies a data transfer from a CPU to a GPU, an explicit directive (#pragma acc data copyout(a[ . . . ])) that explicitly specifies a data transfer from a GPU to a CPU, and an explicit directive (#pragma acc data copy(a[ . . . ])) that explicitly specifies, when a CPU-to-GPU transfer and a GPU-to-CPU transfer are both to be performed on the same variable, those data copies in the both directions collectively.

When a variable defined on the CPU program side is to be referenced by the GPU program side, the data transfer designation section 113 specifies a CPU-to-GPU data transfer at an outermost loop in which neither setting nor definition of the variable is included, among the loop of the loop statement to be processed by the GPU and the outer loops thereof. When a variable set on the GPU program side is to be referenced by the CPU program side, the data transfer designation section 113 specifies a GPU-to-CPU data transfer at an outermost loop in which neither reference, setting, nor definition of the variable is included, among the loop of the loop statement to be processed by the GPU and the outer loops thereof.

The data transfer designation section 113 designates, based on the result of code analysis, GPU processing for loop statements by using at least one selected from the group of directives, of OpenACC, consisting of the ‘kernels’ directive, the ‘parallel loop’ directive, and the ‘parallel loop vector’ directive.

The ‘kernels’ directive of OpenACC is used for single loops and tightly nested loops.

The ‘parallel loop’ directive of OpenACC is used for non-tightly nested loops.

The ‘parallel loop vector’ directive of OpenACC is used for loops that cannot be parallelized but can be vectorized.

### <Parallel Processing Designation Section 114>

The parallel processing designation section 114: identifies loop statements (iteration statements) of the application; and, for each identified loop statement, creates and compiles a plurality of offload processing patterns designated with OpenCL for pipeline processing and parallel processing in the GPU.

The parallel processing designation section 114 includes an offload area extraction section 114a (configured to extract offloadable area) and an intermediate language file output section 114b (configured to output intermediate file).

The offload area extraction section 114a identifies processing offloadable to a GPU, such as loop statements and fast Fourier transformations (FFT), and extracts an intermediate language according to the offload processing.

The intermediate language file output section 114b outputs the extracted intermediate language file 134. The intermediate language extraction is not ended at one time, but is repeated for optimization through execution trials to search for appropriate offload areas.

### <Parallel Processing Pattern Generation Section 115>

The parallel processing pattern generation section 115 excludes, from loop statements to be offloaded, any loop statement (iteration statements) at which a compilation error occurs and generates a plurality of parallel processing patterns (GPU processing patterns) each of which specifies whether to perform parallel processing (GPU processing) for each of the iteration statements at which no compilation error occurs.

### <Performance Measurement Section 116>

The performance measurement section 116 compiles the application according to the generated parallel processing (GPU processing) pattern, deploys the compiled application to the verification machine 14, and performs processing for measuring the performance obtained when offloading the compiled application to the GPU.

The performance measurement section 116 includes a binary file deployment section 116a (configured to deploy binary files). The binary file deployment section 116a deploys an execution file derived from the intermediate language to a verification machine 14 equipped with a GPU and/or an FPGA.

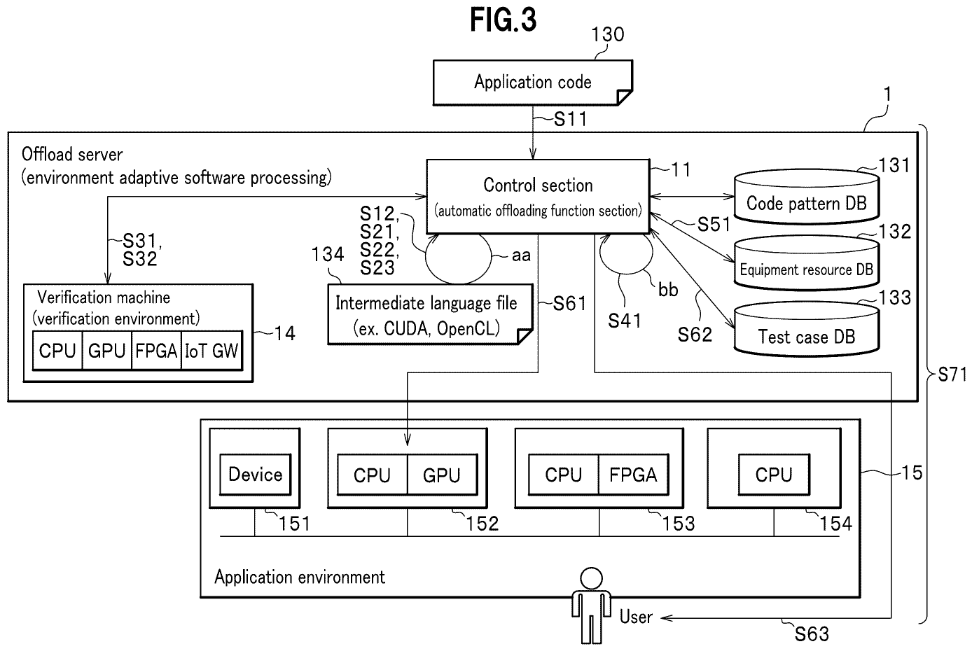

The performance measurement section 116 executes the deployed binary file, measures the performance obtained when offloading is performed and returns the result of the performance measurement to the offload area extraction section 114a. In this case, the offload area extraction section 114a extracts another parallel processing pattern, and the intermediate language file output section 114b carries out a performance measurement for trial based on extracted intermediate language (see reference sign aa in FIG. 3, which will be described later).

### <Execution File Generation Section 117>

The execution file generation section 117 selects a parallel processing pattern with the highest processing performance from all the GPU processing patterns subjected to the performance measurement based on the result of the performance measurement repeated for a predetermined number of times and compiles the application according to the selected GPU processing pattern with the highest processing performance to generate an execution file.

### <Actual Environment Deployment Section 118>

The actual environment deployment section 118 deploys the generated execution file to the actual environment for the user (“deployment of final binary file to actual environment”). The actual environment deployment section 118 determines a pattern that designates the final offload areas, and deploys the pattern to the actual environment for the user.

### <Performance Measurement Test Extraction and Execution Section 119>

After the execution file is deployed, a performance measurement test extraction and execution section 119 extracts performance test items from the test case DB 133 and performs a performance test.

After the execution file is deployed, the performance measurement test extraction and execution section 119 extracts performance test items from the test case DB 133, and performs an automatic execution of the extracted performance test in order to indicate the performance to the user.

### <Request Processing Load Analysis Section 120>

The request processing load analysis section 120 analyzes a request processing load due to the current offload pattern with respect to representative data in commercial circumstances (data actually used by the user).

The request processing load analysis section 120 calculates the actual processing time and the total number of times of use from each application use history in a certain period (long time; for example, one month or the like). Specifically, the request processing load analysis section 120 obtains an improvement factor by (actual processing time with CPU processing only)/(actual processing time with GPU offloading) based on a history of tests that use the use data assumed before the start of the operation. Here, a sum of the values obtained by multiplying the actual processing time by the improvement factor is used as a total processing time used for comparison. The request processing load analysis section 120 compares the total actual processing time across all the applications. Then, the request processing load analysis section 120 reorders the applications in order of the total actual processing time and identifies a plurality of applications with higher processing time loads.

The request processing load analysis section 120 acquires request data in a certain period of the applications with higher loads, aligns the data sizes to increments of a certain size to create a frequency distribution.

### <Representative Data Selection Section 121>

The representative data selection section 121 selects, with respect to an application that has been analyzed by the request processing load analysis section 120 as having a higher processing load, representative data among request data at the time of using the application. Specifically, the representative data selection section 121 selects any one piece of data from actual request data corresponding to a highest-frequency mode of a data size frequency distribution analyzed by the request processing load analysis section 120, and selects the selected data as the representative data.

### <Improvement Level Calculation Section 122>

The improvement level calculation section 122, based on the representative data selected by the representative data selection section 121, determines a new offload pattern (a new offload pattern found in the verification environment) by executing the application code analysis section 112, the parallel processing designation section 114, the parallel processing pattern generation section 115, the performance measurement section 116, and the execution file generation section 117, and compares the processing time and the use frequency of the determined new offload pattern with the processing time and the use frequency of the current offload pattern to calculate a performance improvement effect.

The improvement level calculation section 122 measures the processing times of the current offload pattern and the plurality of new offload patterns, and calculates a performance improvement effect based on the use frequency in commercial circumstances according to (verification environment actual processing reduction time)× (commercial environment use frequency). That is, the improvement level calculation section 122 calculates Formula (1) (verification environment actual processing reduction time)× (commercial environment use frequency) with respect to the current offload pattern for the representative data in commercial circumstances, and calculates Formula (2) (verification environment actual processing reduction time)×(commercial environment use frequency) with respect to the plurality of new offload patterns. Note that the calculation of Formula (1) and Formula (2) may be performed by the reconfiguration suggestion section 123.

Here, specific examples of parameters of the improvement level calculation section 122 in a case where the operation is started while offloading a normal CPU program to a GPU (adaptive processing such as conversion and deployment before the start of the operation) and in a case where request characteristics are analyzed and the GPU logic is changed to another program (reconfiguration after the start of the operation) are as follows.

The improvement level calculation section 122, for a plurality of applications with higher loads, extracts an offload pattern for accelerating test cases of representative data in commercial circumstances, through verification environment measurement. Specifically, the improvement level calculation section 122 counts the number of for statements in an application with a higher load by syntax analysis and finds and removes for statements that cannot be processed by the GPU by the compiler function.

The improvement level calculation section 122 uses the number of the remaining for statement as the gene length, creates a certain number of gene patterns, in which 1 corresponds to GPU execution and 0 corresponds to non-GPU execution, and adds OpenACC directives. Directives are both GPU computation such as ¥#pragma acc kernels and data processing such as ¥#pragma acc data copy.

The improvement level calculation section 122 compiles an OpenACC file corresponding to the gene pattern in the verification environment machine, measures performance with test cases of representative data in commercial circumstances, and sets a higher degree of fitness for a faster pattern.

The improvement level calculation section 122 performs processing such as crossover according to the degree of performance fitness to create a next generation gene pattern. The improvement level calculation section repeats the genetic algorithm processing for a certain number of generations, and uses the final highest performance pattern as a solution.

### <Reconfiguration Suggestion Section 123>

The reconfiguration suggestion section 123 determines a reconfiguration suggestion based on whether the performance improvement level effect of the new offload pattern is equal to or more than a predetermined threshold times that of the current offload pattern. Specifically, the reconfiguration suggestion section 123 checks whether “calculation result of Formula (2)/calculation result of Formula (1)” calculated by the improvement level calculation section 122 is equal to or more than the predetermined threshold, and if “calculation result of Formula (2)/calculation result of Formula (1)” is equal to or more than the predetermined threshold, the reconfiguration suggestion section 123 suggests reconfiguration, and if “calculation result of Formula (2)/calculation result of Formula (1)” is less than the predetermined threshold, the reconfiguration suggestion section 123 does nothing (does not suggest reconfiguration).

### <Provision-to-User Section 124>

The provision-to-user section 124 presents, to the user, information on the price, performance and the like based on the result of the performance test (“provision of information on price, performance and the like to user”). The test case DB 133 stores data for automatically performing the test for measuring the performance of the application. The provision-to-user section 124 presents, to the user, the result of the execution of the test data of the test case DB 133 and the price of the entire system, which is determined from the unit prices of the resources (e.g., virtual machines, FPGA instances and GPU instances) used in the system. On the basis of the presented information on the price, performance and the like, the user determines whether to start using the service with billing.

### [Application of Genetic Algorithm]

The offload server 1 can use GA for optimization of offloading. A configuration of the offload server 1 using a GA is as follows.

Specifically, the parallel processing designation section 114 uses the number of loop statements (iteration statements) at which no compilation error occurs as the gene length, according to a genetic algorithm. The parallel processing pattern generation section 115 maps accelerator processing availability to a gene pattern in such a manner that performing accelerator processing is assigned either 1 or 0 and not performing accelerator processing is assigned either the opposite 0 or 1.

The parallel processing pattern generation section 115 prepares gene patterns of a specified number of individuals such that the gene patterns are each created by randomly setting each value of the genes to 1 or 0, and the performance measurement section 116 compiles an application code that designates statements designating parallel processing by accelerators according to each individual, and deploys the application code in the verification machine 14. The performance measurement section 116 performs processing for measuring the performance on the verification machine 14.

When a gene having the same parallel processing pattern as a former gene appears in an intermediate generation, the performance measurement section 116 does not perform compilation of the application code corresponding to the parallel processing pattern and does not perform performance measurement and uses the same performance measurement value.

In addition, for an application code that causes a compilation error and for an application code with which the performance measurement does not finish within a predetermined time, the performance measurement section 116 handles these cases as time-out cases and sets the performance measurement value to a predetermined time (a long time).

The execution file generation section 117 performs the performance measurement for all the individuals and evaluates them in such a manner that an individual with a shorter processing time is judged as having a higher degree of fitness. The execution file generation section 117 selects, from all the individuals, individuals having a degree of fitness higher than a predetermined value (e.g., top n percent of all the individuals or top m individuals, where n and m are natural numbers) as individuals with high performance and performs crossover and mutation processes to the selected individuals to create individuals of a next generation. After processing for a specified number of generations has been completed, the execution file generation section 117 selects a parallel processing pattern with a highest performance as the solution.

An automatic offload operation of the offload server 1 configured as described above will be described below.

The offload server 1 according to the present embodiment is characterized in that reconfiguration is executed after the start of the operation of a GPU logic. The <automatic offload processing> executed by the offload server 1 as a form of the environment adaptive software is the same between before the start of the operation and the reconfiguration after the start of the operation. That is, the automatic offload processing of the offload server 1 illustrated in FIG. 3 is the same between before the start of the operation and the reconfiguration after the start of the operation, but are different in that data to be handled before the start of the operation is use data assumed, whereas in the reconfiguration after the start of the operation, data to be handled is data actually used commercially (representative data in commercial circumstances).

### [Automatic Offload Operation]

The offload server 1 of the present embodiment is an example in which function processing is applied to an offload server that automatically offloads the function processing to a GPU or the like.

FIG. 3 is a diagram illustrating the automatic offload processing of the offload server 1. The <automatic offload processing> in FIG. 3 is the same between before the start of the operation and the reconfiguration after the start of the operation.

As illustrated in FIG. 3, the offload server 1 is applied to elemental technology of environment adaptive software. The offload server 1 includes a control section (automatic offloading function section) 11 that executes environment adaptive software processing, a code pattern DB 131, an equipment resource DB 132, a test case DB 133, an intermediate language file 134, and a verification machine 14.

The offload server 1 acquires application code 130 to be used by a user.

The user uses OpenIoT resources 15 as a commercial environment. The OpenIoT resources 15 use, for example, a device 151 of any of various types, a CPU-GPU-equipped device 152, a CPU-FPGA-equipped device 153, and a CPU-equipped device 154. The offload server 1 automatically offloads function processing to an accelerator of the CPU-GPU-equipped device 152 and to an accelerator of the CPU-FPGA-equipped device 153.

The offload server 1, using the environment adaptation functions of the commercial environment provided by a business operator and the verification environment, causes the platform functions including the code pattern DB 131, the equipment resource DB 132, and the test case DB 133 to cooperate, to execute the environment adaptive software processing.

Hereinbelow, a description will be given of the operation of each part of the automatic offload operation (before the start of the operation) with reference to step numbers in FIG. 3.

### [Automatic Offload Operation (Before Starting Operation)]

First, code conversion, adjustment of resource amount, adjustment of deployment place, and verification that are necessary before the start of the operation of the application are performed.

### <Step S11: Specify Application Code: Application Code Specification>

In step S11, the application code designation section 111 (see FIG. 2) identifies the processing function (such as image analysis) of the service being provided to the user. Specifically, the application code designation section 111 designates the input application code.

### <Step S12: Analyze Application Code: Analysis of Application Code>

In step S12, the application code analysis section 112 (see FIG. 2) analyzes source code of the processing function and identifies structures such as loop statements and calls to an FFT library.

### <Step S21: Extract Offloadable Area: Extraction of Offloadable Area>

In step S21, the parallel processing designation section 114 (see FIG. 2) identifies loop statements (iteration statements) of the application, specifies parallel processing or pipeline processing in a GPU for each of the iteration statements, and performs compilation using a high-level synthesis tool. Specifically, the offload area extraction section 114a (see FIG. 2) identifies processing offloadable to an FPGA, such as loop statements, and extracts OpenCL as intermediate language according to the offload processing.

### <Step S22: Output Intermediate File: Output of the Intermediate Language File>

In step S22, the intermediate language file output section 114b (see FIG. 2) outputs the intermediate language file 134. The intermediate language extraction is not ended at one time, but is repeated for optimization through execution trials to search for appropriate offload areas.

### <Step S23: Compile Error: Parallel Processing Pattern Creation>

In step S23, the parallel processing pattern generation section 115 (see FIG. 2) excludes, from loop statements to be offloaded, any loop statement at which a compilation error occurs and generates a plurality of parallel processing patterns (GPU processing patterns) each of which specifies whether to perform GPU processing for each of the iteration statements at which no compilation error occurs.

### <Step S31: Deploy Binary Files: Deployment of Execution Files>

In step S31, the binary file deployment section 116a (see FIG. 2) deploys an execution file derived from the intermediate language to the verification machine 14 equipped with a GPU. The binary file deployment section 116a launches the deployed file and executes an assumed test case to measure the performance obtained when offloading is performed.

### <Step S32: Measure Performance: Performance Measurement for Proper Pattern Search>

In step S32, the performance measurement section 116 (see FIG. 2) executes the deployed file to measure the performance obtained when offloading is performed.

In order to make offload areas more appropriate, the result of the performance measurement is returned to the offload area extraction section 114a. Then, the offload area extraction section 114a extracts another pattern. Then, the intermediate language file output section 114b carries out a performance measurement for trial based on the extracted intermediate language (see reference sign aa in FIG. 3). The performance measurement section 116 repeats the performance measurement on the verification environment and determines a final code pattern to deploy.

As illustrated by reference sign aa in FIG. 3, the control section 11 repeats above-described steps S12 to S23. The automatic offloading function of the control section 11 is summarized as follows. The parallel processing designation section 114 identifies loop statements (iteration statements) of the application, specifies parallel processing or pipeline processing on the GPU for each of the iteration statements according to OpenCL, and performs compilation using a high-level synthesis tool. Then, the parallel processing pattern generation section 115 excludes, from loop statements to be offloaded, any loop statement at which a compilation error occurs and generates a plurality of parallel processing patterns each of which specifies whether to perform parallel processing for each of the loop statements at which no compilation error occurs. Then, for each of the plurality of parallel processing patterns, the binary file deployment section 116a compiles the application according to the parallel processing pattern and deploys the compiled application to the verification machine 14 and the performance measurement section 116 executes processing for measuring the performance on the verification machine 14. The execution file generation section 117 selects a pattern with the highest processing performance from all the parallel processing patterns subjected to the performance measurement based on a result of the performance measurement repeated for a predetermined number of times, and compiles the application according to the selected pattern to generate an execution file.

### <Step S41: Determination of Resource Size>

The control section 11 determines a resource size (see reference sign bb in FIG. 3).

### <Step S51: Selection of Appropriate Deployment Place>

The control section 11 consults the equipment resource DB 132 to select an appropriate deployment place.

### <Step S61: Deploy Final Binary Files to Production Environment: Deployment of Final Files to Commercial Environment>

In step S61, the actual environment deployment section 118 determines a pattern that designates the final offload areas, and deploys the pattern to the actual environment for the user.

### <Step S62: Extract Performance Test Cases and Run Automatically: Test Case Extraction and Normality Confirmation>

In step S62, after the execution file is deployed, the performance measurement test extraction and execution section 119 extracts performance test items from the test case DB 133, and performs an automatic execution of the extracted performance test in order to indicate the performance to the user.

### <Step S63: Provide Price and Performance to a User to Judge: Presentation of Price and Performance for the User to Determine Whether to Start the Use>

In step S63, the provision-to-user section 124 presents, to the user, information on the price, performance and the like based on the result of the performance test. Based on the presented information on the price, performance and the like, the user determines whether to start using the service with billing.

The above-described steps S11 to S63 are performed in the background of service use of the user, and are assumed to be performed on the first day of temporary use of the service, for example. Furthermore, in order to reduce the cost, the processing to be performed in the background may be performed only for offloading to a GPU/FPGA.

As described above, when the offload server 1 is applied to an elemental technology of environment adaptive software, the control section (automatic offloading function section) 11 of the offload server 1 extracts the areas to be offloaded from the source code of the application used by the user and outputs an intermediate language, in order to offload function processing (steps S11 to S23). The control section 11 deploys the execution file derived from the intermediate language to the verification machine 14 and causes the verification machine 14 to execute the execution file to verify the effect of offloading (steps S31 to S32). The control section 11 repeats the verification, then determines appropriate offload areas, and then deploys the execution file to an actual environment that is actually provided to the user, to provide the execution file as a service (steps S41 to S63).

The processing flow of collectively performing the code conversion, the resource amount adjustment, and the deployment place adjustment, which are required for environment adaptation, has been described. However, it should be noted that this is not limiting and only desired processing may be extracted. For example, when only a code conversion is desired to be performed for a GPU, it is possible to use only the environment adaptation function and the verification environment in the steps S11 to S63.

### <GPU Automatic Offloading>

The above-described code analysis uses a syntax analysis tool, such as Clang, to analyze the application code. It is difficult to generalize the code analysis because it requires an analysis be performed assuming the device to which offloading is to be performed. However, it is possible to identify the structure of code such as reference relationships between loop statements and variables and to identify function blocks that perform FFT processing or calls to a library that performs FFT processing. It may be difficult for the offload server to automatically identify such function blocks. Such function blocks can be identified through similarity determination using a similar code detection tool such as Deckard. Here, Clang is a tool for C/C++. A tool that is appropriate for the language to be analyzed need to be selected.

Furthermore, when processing of an application is to be offloaded, consideration is required depending on the offload destination device, such as a GPU, FPGA, or IoT GW. In general, it is difficult to automatically find a setting that results in the maximum performance on the first try. Therefore, offload patterns are tried several times in a verification environment while repeating performance measurement, thereby finding a pattern that can achieve acceleration.

### [GPU Automatic Offloading Using GA]

Automatic acceleration using GA will be described. The automatic acceleration using GA is used in an automatic offload operation (before starting operation).

GPU automatic offloading is a process of, for a GPU, repeating steps S21 to S23 and S31 to S32 illustrated in FIG. 3, to finally obtain an offloading code to be deployed in steps S61 to S63.

GPU is a device that generally does not guarantee latency but is suitable for improving throughput by parallel processing. There are a wide variety of applications to be run in IoT. Typical applications are encryption processing of IoT data, image processing for analysis of camera videos, machine learning processing for analysis of a large amount of sensor data and the like and they include a lot of repetitive processing. In view of this, iteration statements in an application are automatically offloaded to a GPU, thereby to attempt acceleration.

However, as described in connection with the conventional art, appropriate parallel processing is required for acceleration. When a GPU is used in particular, it is often the case that when the data size and the number of loop iterations are small, performance cannot be improved due to memory transfer between a CPU and the GPU. Further, due to the timing of memory data transfer, a combination of individual loop statements (iteration statements) that can be processed in parallel for acceleration may not result in the highest speed. For example, even if the first, fifth, and tenth for statements among 10 for statements (iteration statements) can achieve acceleration compared to using the CPU, the combination of the three for statements does not necessarily be the highest speed option.

There is known an attempt of designating an appropriate parallel processing areas by determining whether for statements are parallelizable by trial and error for optimization, by using PGI compiler. However, the trial-and-error approach requires a lot of operations and, in the event of providing the service, delays the start of the service to be used by the user and increases the cost.

In view of this, the present embodiment automatically extracts appropriate offload areas from a general program that does not assume parallelization. For this purpose, the embodiment first checks parallelizable for statements and then, for a group of parallelizable for statements, repeatedly performs a performance verification trial on a verification environment using GA to search for appropriate areas. By narrowing down to parallelizable for statements and then retaining and recombining accelerable parallel processing patterns in the form of portions of genes, a pattern that can be efficiently accelerated can be searched for from a huge number of possible parallel processing patterns.

### [Concept of Search by Control Section (Automatic Offloading Function Section) 11 Using Simple GA]

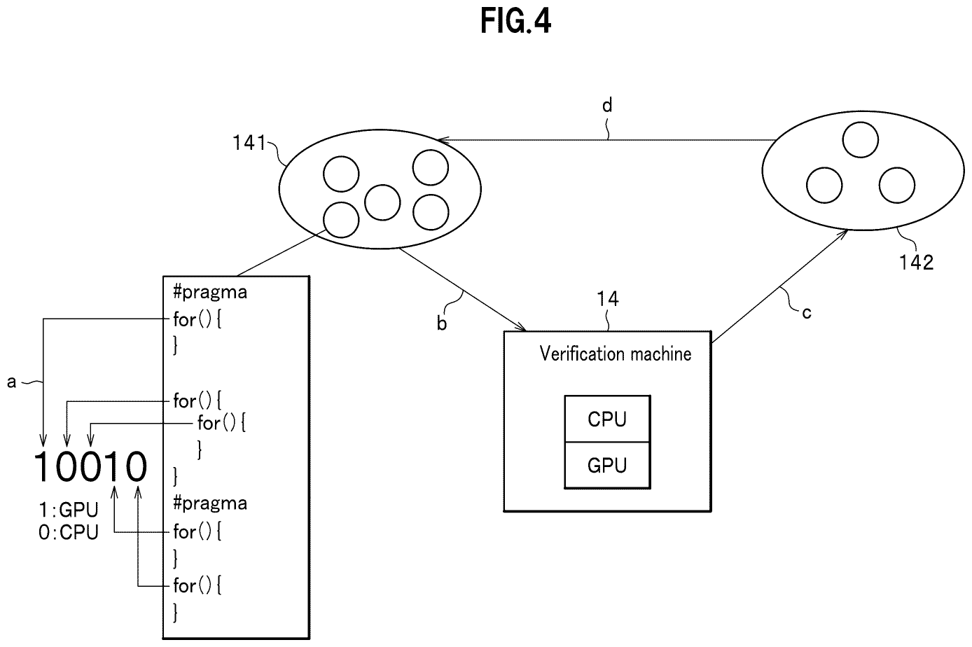

FIG. 4 is a diagram illustrating a concept of a search process by a control section (automatic offloading function section) 11 using Simple GA. FIG. 4 illustrates the concept of the search process and illustrates gene sequence mapping of for statements.

GA is a combination optimization technique that mimics the evolutionary process of living organisms. The flowchart of the GA is: initialization->evaluation->selection->crossover->mutation->termination determination.

In the present embodiment, Simple GA, which uses simplified processing, will be used among GAs. Simple GA is a simplified GA, in which a gene consists only of 1's and 0's, roulette-wheel selection and one-point crossover are employed, and mutation is performed by flipping the value of the gene in one position from 1 to 0 or vice versa.

### <Initialization>

In the initialization, the parallelizability of all the for statements in the application code is checked and then the parallelizable for statements are mapped to a gene sequence. When GPU processing is to be performed, 1 is set while when GPU processing is not to be performed, 0 is set. The genes are prepared for a specified M number of individuals in such a manner that one for statement is assigned a value of 1 or 0 randomly.

Specifically, the control section (automatic offloading function section) 11 (see FIG. 2) retrieves application code 130 (see FIG. 3) used by the user and checks the parallelizability of the for statements on the basis of the code patterns 141 of the application code 130 as illustrated in FIG. 4. As illustrated in FIG. 4, when five for statements are found in the code pattern 141 (see reference sign a in FIG. 4), one digit of 1 or 0 is randomly assigned for each for statement, and here, five digits of 1 or 0 are assigned to the five for statements. For example, the cases in which the processing is to be performed by the CPU are assigned a value of 0, and the cases in which processing is to be outsourced to the GPU are assigned a value of 1. In this stage, however, a value of 1 or 0 is randomly assigned.

Code corresponding to a gene length consists of five digits and there are 25=32 patterns of code with a gene length of five digits, for example: 10001, 10010, . . . and so on. It should be noted that circles in the code pattern 141 conceptually represent the code in FIG. 4.

### <Evaluation>

In the evaluation, deployment and performance measurement are performed (see reference sign b in FIG. 4). Specifically, the performance measurement section 116 (see FIG. 2) compiles code corresponding to genes, deploys the compiled code to the verification machine 14, and executes the deployed code. The performance measurement section 116 performs a benchmark performance measurement. A gene corresponding to a pattern (parallel processing pattern) with good performance is given a higher degree of fitness.

### <Selection>

In the selection, on the basis of the degree of fitness, high performance code patterns are selected (see reference sign c in FIG. 4). On the basis of the degrees of fitness, the performance measurement section 116 (see FIG. 2) selects genes with high degrees of fitness as many as a specified number of individuals. The present embodiment performs roulette-wheel selection according to the degree of fitness and elite selection of selecting the gene with the highest degree of fitness.

FIG. 4 illustrates, as the concept of the search process, that the number of circles in selected code patterns 142 has decreased to three.

### <Crossover>

In the crossover, some of the genes are swapped between selected individuals at one point at a certain crossover rate Pc to generate child individuals.

A gene of a certain pattern (parallel processing pattern) selected by roulette-wheel selection is crossed with a gene of another pattern. The position of the one-point crossover is arbitrary; for example, the crossover point may be the third digit in the five-digit code described above.

### <Mutation>

In the mutation, values of a gene of an individual are changed from 0 to 1 or 1 to 0 at a certain mutation rate Pm.

Further, in order to avoid a local solution, mutation is introduced. It should be noted that, in some modes, mutation may be omitted in order to reduce the amount of computation.

### <Determination of Termination>

As illustrated in FIG. 4, next-generation code patterns are generated after the crossover and mutation processes are performed (see reference sign d in FIG. 4).

In the determination of termination, the process is terminated after the process is repeated a number of times equal to a specified T number of generations, and a gene with the highest degree of fitness is selected as the solution.

For example, performance measurement is performed and three fast patterns, 10010, 01001, and 00101 are selected. The three patterns are recombined in the next generation using the GA to generate a new pattern (parallel processing pattern) 10101 (an example). Here, mutation is introduced into the recombined patterns by, for example, automatically replacing 0 with 1. This process is repeated to find the fastest pattern. The specified number of generations (for example 20 generations) is defined and a pattern left in the last generation is selected as the final solution.

### <Deployment>

With a parallel processing pattern having a highest processing performance corresponding to the gene with the highest degree of fitness, the deployment to the actual environment is performed anew to provide it to the user.

### Supplemental Remarks

A description will be given of a case in which a considerable number of for statements (loop statements/iteration statements) that cannot be offloaded to a GPU are present. For example, even in a case in which 200 for statements are present, only about 30 for statements may be offloaded to a GPU. Here, the statements that cause errors are excluded and a GA is performed for the 30 statements.

OpenACC provides a compiler that allows specifying “#pragma acc kernels” directives to extract bytecode for GPU and to perform GPU offloading by executing the bytecode. By writing a command for a for statement in this #pragma, it is possible to determine whether the for statement can operate on the GPU.

In a case of using C/C++, the C/C++ code is analyzed to find for statements. When a for statement is found, a statement is written for the for statement using “#pragma acc kernels”, which is a syntax defined in OpenACC for parallel processing. Specifically, for statements are inserted into an empty “#pragma acc kernels” one by one and compiled. If an error occurs for a for statement, the for statement cannot be processed by the GPU in the first place and thus is excluded. In this way, remaining for statements are found. Then, the number of the for statements that do not cause errors are used as the length (gene length). If the number of for statements not causing an error is 5, the gene length is 5; and if the number of for statements not causing an error is 10, the gene length is 10. Note that one that cannot be processed in parallel is a case with a data dependency in which a previous processing is used for the next processing.

The process up to here is in the preparation stage. The GA process is carried out next.

Up to here, code patterns with a gene length corresponding to the number of the for statements have been obtained. Initially, parallel processing patterns, e.g., 10010, 01001, 00101, . . . , are assigned randomly. GA processing is performed, and compilation is performed. In this event, an error could occur even with a for statement that is offloadable. This is the case in which the for statement is in a hierarchy (GPU processing is possible by designating either one of the hierarchy). In such a case, the for statement having caused the error may be retained. Specifically, it is conceivable to cause a timeout as if the timeout has been generated due to an increased processing time.

Deployment is performed on the verification machine 14 and, in the case of image processing, for example, the image processing is tested by benchmark testing and code patterns resulting in shorter processing time are evaluated as having a higher degree of fitness. For example, the evaluation is given as an inverse of the processing time. A value of 1 is given to processing that takes 10 seconds; a value of 0.1 is given to processing that takes 100 seconds; and a value of 10 is given to processing that takes 1 second.

For example, three to five code patterns with higher degrees of fitness are selected from 10 code patterns and recombined to generate new code patterns. In the course of the generation, a code pattern that is identical to a former code pattern may be generated. In such a case, the same data as before is used because the same benchmark testing does not need to be performed. In the present embodiment, code patterns and their processing times are stored in the storage section 13.

The concept of the search process by the control section (automatic offloading function section) 11 using Simple GA has been described above. A collective processing technique for data transfer will be described next.

### [Collective Data Transfer Processing Technique]

### <Basic Concept>

In order to reduce the number of transfers between a CPU and a GPU, the present invention transfers variables of nested loops, at an outermost possible level, and, in addition, concentrates the timing of transferring many variables and reduces the number of transfers that are caused by the compiler automatically.

To reduce the number of transfers, variables are transferred not only on a per nested-loop basis but are transferred such that variables for which the timing of transferring to the GPU can be concentrated are collectively transferred. For example, variables defined on a CPU and used in a plurality of loop statements, except those which are obtained as a result of processing by the GPU, then processed on the CPU, and then processed on the GPU again, can be collectively transferred to the GPU before the start of the GPU processing and can be returned to the CPU after the completion of the entire GPU processing.

As the loops and reference relationships between variables are identified when the code is analyzed, on the basis of the result thereof, a ‘data copy’ statement of OpenACC is used to designate a transfer of collectively transferring, of the variables defined in the plurality of files, those for which the GPU processing and the CPU processing are not nested and thus it is possible to separate the GPU processing and the CPU processing.

Variables that have been collectively transferred before the start of GPU processing and do not need to be transferred at the timing of loop statement processing are explicitly so indicated using ‘data present’.

When data is to be transferred between the CPU and the GPU, a transfer is designated by creating (#pragma acc declare create) a temporary area, storing the data in the temporary area, and then synchronizing (#pragma acc update) the temporary area.

### Comparative Examples

Comparative examples will be described first.

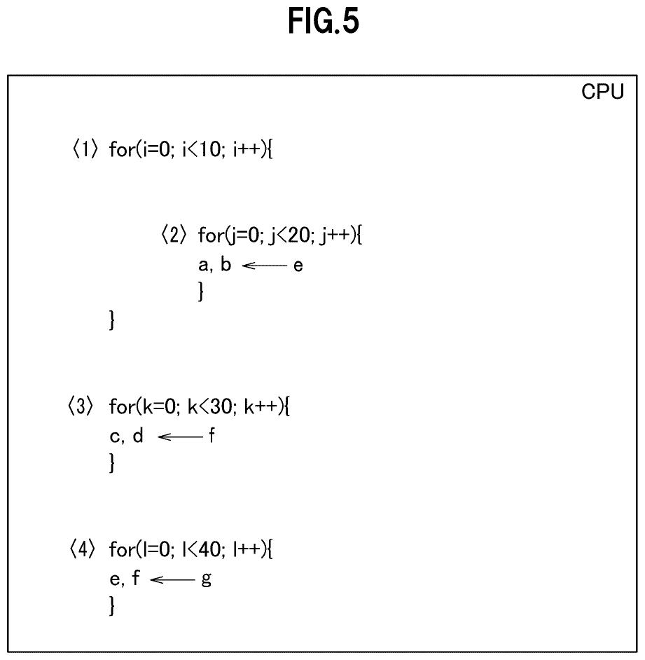

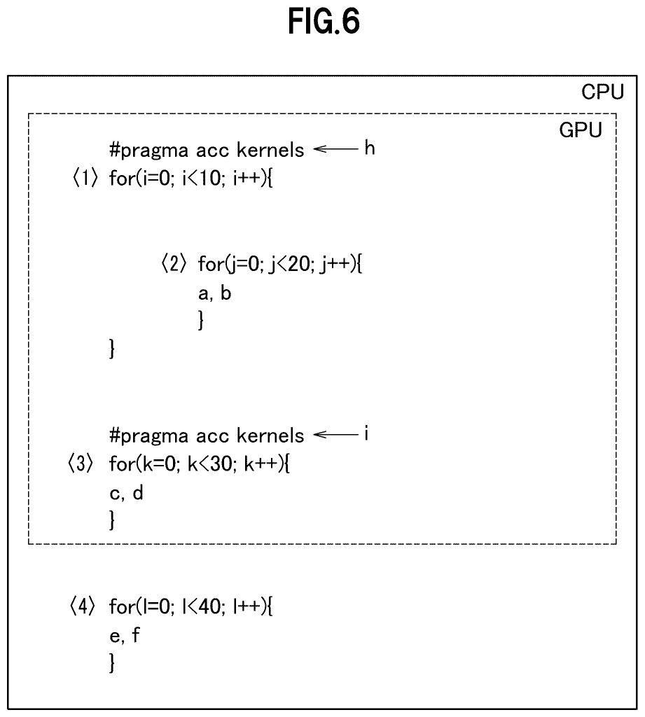

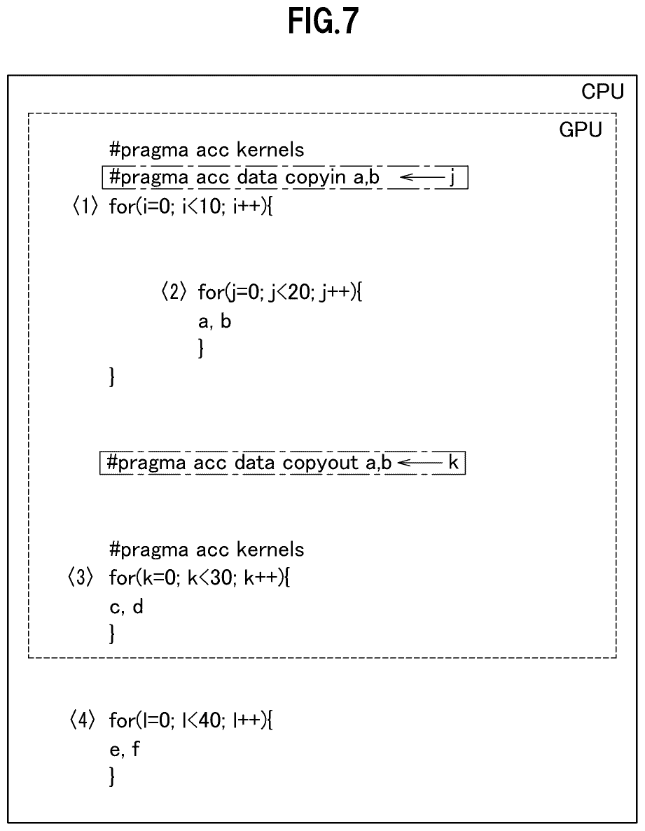

The comparative examples include a conventional CPU program (see FIG. 5), simple GPU use (see FIG. 6), and collective nest processing (Non-Patent Literature 2) (see FIG. 7). Incidentally, numbers <1> to <4>indicated after loop statements denoted in the succeeding description and in the drawings are given for the sake of convenience of explanation (the same applies to other figures and explanations thereof).

The loop statements in the ordinary CPU program illustrated in FIG. 5 are written on the CPU program side, where:

```
  loop <1> [for(i=0; i<10; i++)] {
}
contains
loop <2> [for(j=0; j<20; j++] {
}.
  The reference sign e in FIG. 5 is a
  setting of variables a,b in above loop <2>.
  Further,
loop <3> [for(k=0; k<30; k++)] {
}
and
loop <4> [for(l=0; l<40; 1++] {
}
```

follow. The reference sign f in FIG. 5 is a setting of variables c,d in the loop <3>, and the reference sign g in FIG. 5 is a setting of variables e,f in the loop <4>.

The conventional CPU program illustrated in FIG. 5 is executed on the CPU (no GPU is used).

FIG. 6 is a diagram illustrating loop statements in the case where a data transfer from a CPU to a GPU is performed by simply using the GPU for the conventional CPU program illustrated in FIG. 5. The types of data transfer include a data transfer from CPU to GPU and a data transfer from GPU to CPU. In the following description, a data transfer from CPU to GPU is taken as an example.

The loop statements illustrated in FIG. 6, which simply use a GPU, are written in the CPU program side, where:

loop <1> [for(i=0; i<10; i++)] {
}
contains
loop <2> [for(j=0; j<20; j++] {
}.

Further, as indicated by reference sign h in FIG. 6, a processing portion such as for statements that can be parallelized by PGI compiler is designated with a directive #pragma acc kernels (statement designating parallel processing) of OpenACC above loop <1> [for (i=0; i<10+i++]{

}.

As illustrated in the dashed box containing reference sign h in FIG. 6, data is transferred from the CPU to the GPU according to #pragma acc kernels. Here, 10 transfers are performed since a and b are transferred at this timing.

Further, as indicated by reference sign i in FIG. 6, a processing portion such as for statements that can be parallelized by PGI compiler is designated with a directive #pragma acc kernels of OpenACC above loop <3> [for k=0; k<30; k++)]{

}.

As illustrated in the dashed box containing reference sign i in FIG. 6, c and d are transferred according to #pragma acc kernels at this timing.

Here, #pragma acc kernels is not designated above <4>loop [for (1=0; 1<40; 1++)]{ }. This loop is not processed on the GPU because processing of this loop on the GPU is inefficient.

FIG. 7 is a diagram illustrating loop statements in the case where data is transferred from the CPU to the GPU and from the GPU to the CPU using collective nest processing (Non-Patent Literature 2).

In the loop statement illustrated in FIG. 7, the CPU-to-GPU data transfer directive line #pragma acc data copyin(a, b), a copyin clause of the variables a and b, is inserted at the position indicated by reference sign j in FIG. 7.

The above-described #pragma acc data copyin(a, b) is specified at the outermost loop including neither setting nor definition of variables a, b (in this case, above loop <1> [for (i=0; i<10; i++)]{

}).

As a and b are transferred at the timing indicated in the dash-dotted box containing reference sign j in FIG. 7, transfer occurs once.

In the loop statements illustrated in FIG. 7, the GPU-to-CPU data transfer directive line #pragma acc data copyout(a, b), a copyout clause of variables a and b, is inserted at the position indicated by reference sign k in FIG. 7.

The above-described #pragma acc data copyout(a, b) is specified below loop <1> [for (i=0; i<10; i++)]{

}.

In this way, in data transfer from the CPU to the GPU, data transfer is explicitly indicated by inserting a copyin clause of variables a, b: #pragma acc data copyin(a, b), at the position described above. This allows data transfers to be collectively performed at a time at the outermost possible loop, thereby avoiding inefficient transfer in which data is transferred at every loop as in the simple use of GPU by the loop statements indicated by reference sign h in FIG. 6.

### Embodiment

The present embodiment will be described next.

<<Use of ‘Data Present’ to Explicitly Indicate Variables that Need not be Transferred>>

In the present embodiment, a ‘data copy’ statement of OpenACC is used to designate a transfer of collectively transferring, of the variables defined in the plurality of files, those for which the GPU processing and the CPU processing are not nested and thus it is possible to separate the GPU processing and the CPU processing. In addition, variables that have been collectively transferred and do not need to be transferred at the timing are explicitly indicated using ‘data present’.

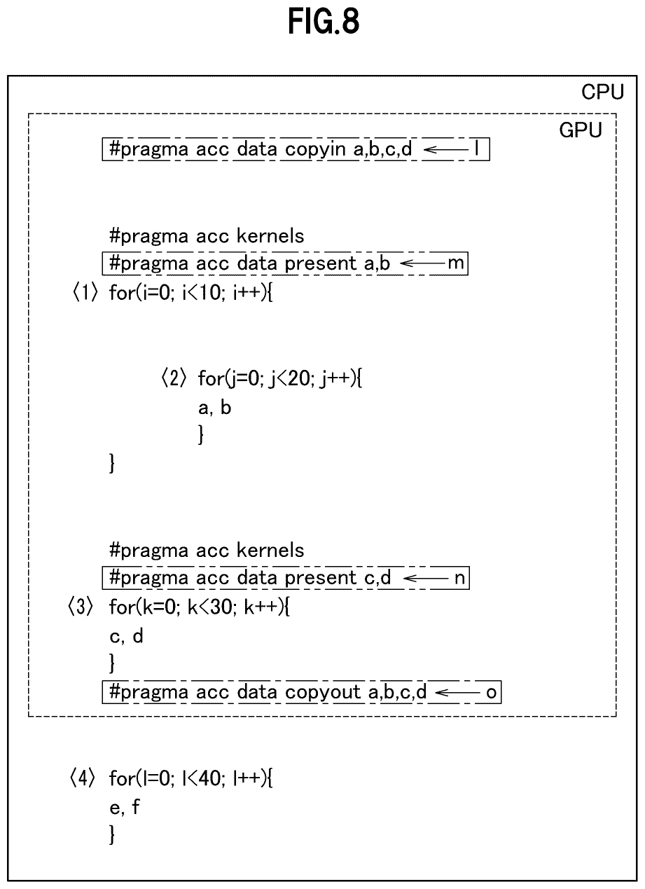

FIG. 8 is a diagram illustrating loop statements for which collective transfers are employed according to the present embodiment for data transfers between a CPU and a GPU. FIG. 8 corresponds to the collective nest processing of the comparative example in FIG. 7.

In the loop statements illustrated in FIG. 8, the CPU-to-GPU data transfer directive line #pragma acc datacopyin(a, b, c, d), a copyin clause of the variables a, b, c, and d, is inserted at the position indicated by reference sign l in FIG. 8.

The above-described #pragma acc data copyin(a, b, c, d) is specified at the outermost loop including neither setting nor definition of variables a, b, c, d (in this case, above loop <1> [for (i=0; i<10; i++)]{

}).

In this way, the ‘data copy’ statement #pragma acc data copyin(a, b, c, d) of OpenACC is used to designate a transfer of collectively transferring, of the variables defined in the plurality of files, those for which the GPU processing and the CPU processing are not nested and thus it is possible to separate the GPU processing and the CPU processing.

As a, b, c, and d are transferred at the timing indicated in the dash-dotted box containing reference sign l in FIG. 8, transfer occurs once.

The variables that have been collectively transferred using the above-described #pragma acc data copyin(a, b, c, d) and need not be transferred at a certain timing are designated using ‘data present’ statement #pragma acc data present (a, b), which explicitly indicates that the variables are already on the GPU at the timing indicated in the long dashed double-short dashed line box containing reference sign m in FIG. 8.

The variables that have been collectively transferred using the above-described #pragma acc data copyin(a, b, c, d) and need not be transferred at a certain timing are designated using ‘data present’ statement #pragma acc data present (c, d), which explicitly indicates that the variables are already on the GPU at the timing indicated in the long dashed double-short dashed line box containing reference sign n in FIG. 8.

At the timing where loops <1> and <3> have been subjected to GPU processing and the GPU processing is finished, the GPU-to-CPU data transfer directive line #pragma acc data copyout(a, b, c, d), which is a copyout clause of variables a, b, c, d, is inserted at the position of reference sign o at which loop <3> has been finished, as illustrated in FIG. 8.

Variables that can be collectively transferred using designation of collective transfer are collectively transferred, and variables that have been already transferred and need not be transferred are explicitly indicated using ‘data present’, thereby reducing the number of transfers to further improve efficiency of offloading means. However, even if transfer is specified according to OpenACC, some compilers may perform transfer due to its automatic determination. Automatic transfer by a compiler is an event in which, unlike the instruction according to OpenACC, a transfer between a CPU and a GPU that is actually unnecessary is nevertheless automatically performed in a manner of depending on the compiler.

### <<Storing Data in Temporary Area>>

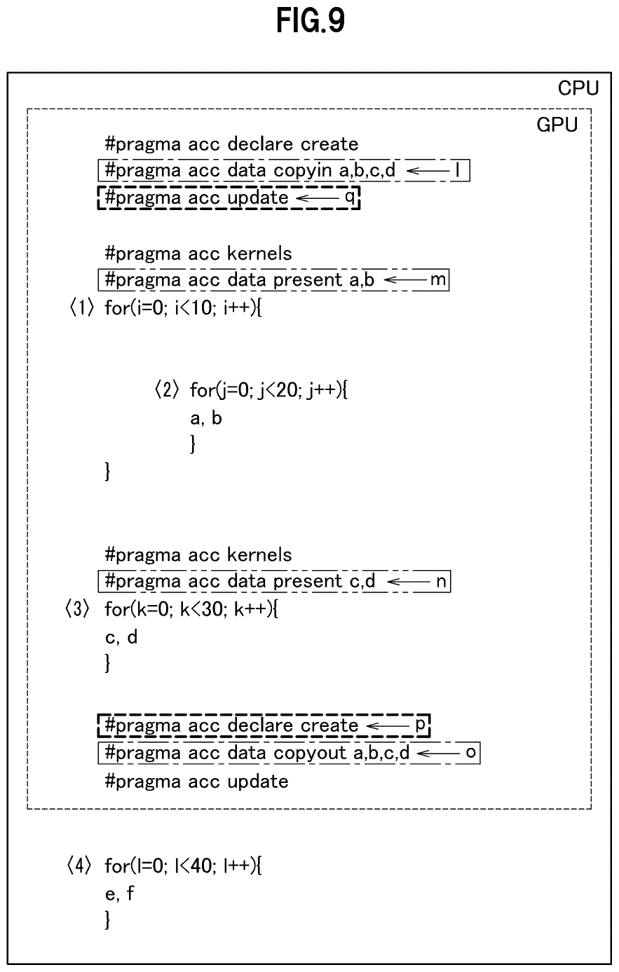

FIG. 9 is a diagram illustrating loop statements for which collective transfers are employed according to the present embodiment for data transfers between a CPU and a GPU. FIG. 9 corresponds to the collective nest processing and the explicit indication of variables that need not be transferred, illustrated in FIG. 8.

In the loop statements illustrated in FIG. 9, a ‘declare create’ statement of OpenACC: #pragma acc declare create, which creates a temporary area when a data transfer between a CPU and a GPU is performed, is specified at the position indicated by reference sign p in FIG. 9. This causes a temporary area to be created (#pragma acc declare create) and causes data to be stored in the temporary area when a data transfer is performed between the CPU and GPU.

Moreover, a ‘declare create’ statement of OpenACC, “#pragma acc update”, which is used to synchronize the temporary area, is inserted at the position indicated by reference sign q in FIG. 9, thereby instructing to perform a transfer.

In this way, a temporary area is created, and parameters are initialized in the temporary area to be used in the transfer between the CPU and the GPU, which avoids unnecessary transfers between the CPU and the GPU. Transfers that are not intended by OpenACC instructions and that degrade performance can be reduced.

### [GPU Offload Processing]

By the above-described collective data transfer processing technique, loop statements appropriate for offloading can be extracted, and inefficient data transfer can be avoided.

However, some programs are not suitable for being offloaded to a GPU using the collective data transfer processing technique described above. In order for offloading to a GPU to be effective, it is necessary that the number of loop iterations of the processing to be offloaded be large.

In view of this, the present embodiment checks the number of loop iterations using a profiling tool in a preliminary step before a full-scale offload processing finding operation. As the number of executions of each line can be checked using a profiling tool, programs can be sorted out beforehand so that, for example, programs that have more than 50 million loop iterations are selected as programs to which an offload processing finding operation is to be applied. The process will be described below in detail (some portions of the description overlap portions of the description given with reference to FIG. 3).

In the present embodiment, first an application in which offload processing portions are to be searched for is analyzed to identify loop statements such as for, do, and while statements. Then, sample processing is performed, and the number of loop iterations of each loop statement is checked using the profiling tool and determination is made as to whether to perform a full-scale offload processing portion finding operation, based on whether there are loops that iterate a predetermined number of times or more.

When it is determined that a full-scale search operation is to be performed, GA processing is started (see FIG. 4 described above). In the initialization step, all loop statements in the application code are checked to determine whether they are parallelizable, then parallelizable loop statements are mapped to a gene sequence by setting 1 if GPU processing is to be performed and setting 0 if GPU processing is not to be performed. The genes are prepared for a specified number of individuals in such a manner that the values of each individual are each assigned a value of 1 or 0 randomly.

Here, in the code corresponding to a gene, an explicit data transfer instruction (#pragma acc data copyin/copyout/copy) is added according to the reference relationships of variable data in the loop statement designated as being subjected to GPU processing.

In the evaluation step, the code corresponding to the gene is compiled, deployed to a verification machine, and executed on the verification machine. Then, a benchmark performance measurement is performed. A gene corresponding to a pattern with good performance is given a higher degree of fitness. In the code corresponding to the gene, a parallel processing directive line (see reference sign e in FIG. 5, for example) and a data transfer directive line (see reference sign g in FIG. 5, reference sign h in FIG. 6, and reference sign j in FIG. 7, for example) are inserted, as described above.

In the selection step, genes with high degrees of fitness as many as the specified number of individuals are selected based on the degree of fitness. The present embodiment performs roulette-wheel selection according to the degree of fitness and elite selection of selecting the gene with the highest degree of fitness. In the crossover step, some of the genes are swapped between selected individuals at one point at a certain crossover rate Pc, thereby generating child individuals. In the mutation step, values of a gene of an individual are changed from 0 to 1 or 1 to 0 at a certain mutation rate Pm.

After the mutation step is finished and next-generation genes as many as the specified number of individuals are generated, explicit data transfer instructions are added as in the initialization step, and the evaluation, selection, crossover, and mutation steps are repeated.

Lastly, at the termination determination step, the process is terminated after the process is repeated a number of times equal to a specified number of generations, the process is terminated and a gene with the highest degree of fitness is selected as the solution. With a code pattern having a highest performance corresponding to the gene with the highest degree of fitness, the deployment to the actual environment is performed anew to provide it to the user.

Hereinbelow, a description will be given of an implementation of the offload server 1. This implementation was made to confirm the validity of the present embodiment.

### [Implementation]

A description will be given of an implementation that automatically offloads a C/C++ application using the general-purpose PGI compiler.

As the purpose of the implementation is to confirm the validity of the GPU automatic offloading, the target application is a C/C++ application and the GPU processing itself is described using conventional PGI compiler.

C/C++ languages are quite popular in the development of Open Source Software (OSS) and proprietary software. Many applications have been developed in C/C++ language. To verify the offloading of applications used by general users, we use OSS general applications such as one for cryptographic processing or image processing.

Processing for GPU is compiled with PGI compiler. PGI compiler is a compiler that interprets OpenACC for C/C++/Fortran languages. In the present embodiment, parallelizable processing portions such as for statements are designated with an OpenACC directive, #pragma acc kernels (statement designating parallel processing). This allows bytecode for GPU to be extracted and executed on the GPU, thereby enabling GPU offloading. The present embodiment issues an error in such a case that parallel processing is not possible due to the dependency between data in for statements or that plural hierarchies in nested for statements are specified. In addition, the present embodiment allows specifying explicit data transfers by directives #pragma acc data copyin/copyout/copy and the like.

Data transfer is explicitly specified by inserting #pragma acc data copyout(a[ . . . ]), which is the copyin clause of OpenACC, in the position described above in addition to the designation of “#pragma acc kernels (statement designating parallel processing).

### <Overview of Operation of Implementation>

An overview of operation of an implementation will be described.

For the implementation, the following process is performed.

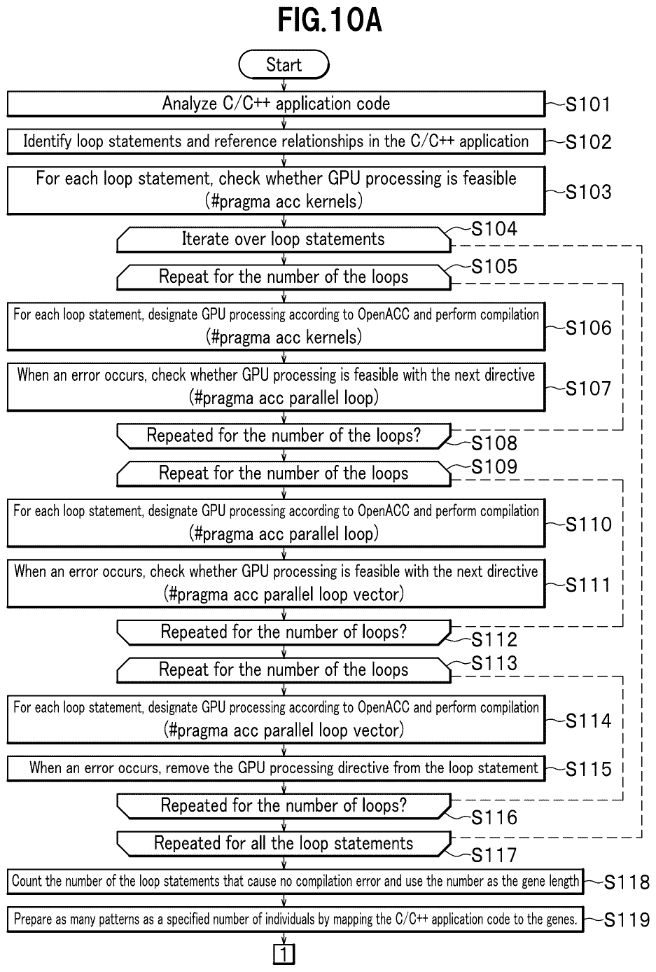

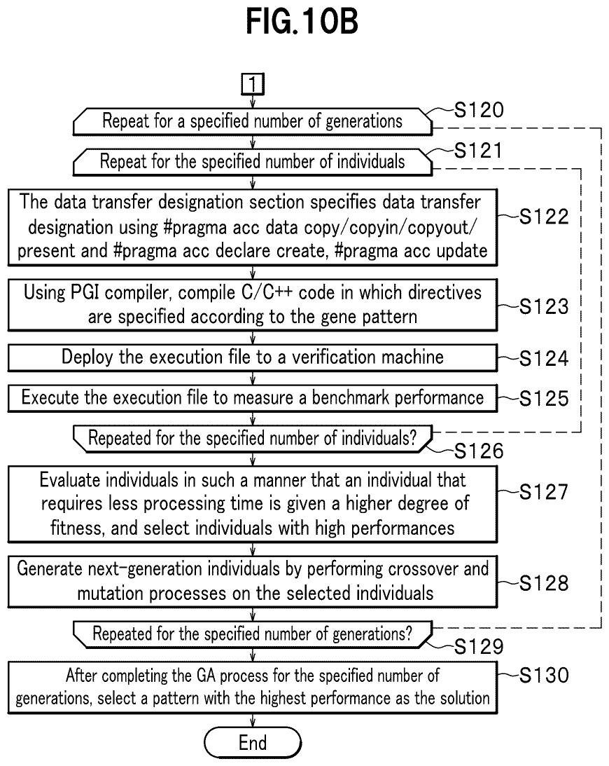

Before starting the later-described flow illustrated in FIGS. 10A and 10B, a C/C++ application to be accelerated and a benchmark testing tool for measuring the performance of the application are provided.

In the implementation, when a request for using the C/C++ application is received, the code of the C/C++ application is first analyzed to find for statements and identify a program structure regarding such as variable data used in the for statements. A syntax analysis library such as LLVM/Clang is used to perform syntax analysis.

In the implementation, in order to estimate the possibility of effectiveness of GPU offloading on the application, benchmark testing is performed first and the number of loop iterations of the for statements identified in the syntax analysis is identified. For identifying the number of loop iterations, gcov of GNU coverage or the like is used. Known profiling tools include “GNU profiler (gprof)” and “GNU coverage (gcov)”. Either one of these tools may be used since both tools can check the number of execution iterations of each line. Only an application that has more than 10 million loop iterations, for example, may be processed; the threshold value can be changed.

Implementations of general applications for CPU are not intended to be parallelized. Therefore, for statements for which GPU processing itself cannot be performed need to be excluded first. For each of the for statements, insertion of #pragma acc kernels directive for parallel processing is tried to determine whether an error occurs during compilation. There are several types of compilation errors. Examples of the compilation errors include: a case in which an external routine is called in a for statement; a case in which different nesting levels are duplicatively specified in nested for statements; a case in which there is a process that exits a for statement in the middle due to a break or the like; and a case in which there is a data dependency in data of a for statement. Types of errors that occur during compilation vary from application to application and errors other than discussed above may occur. Compilation errors are excluded from the processing and #pragma directives are not inserted.

Compilation errors are difficult to be processed automatically. In addition, it is often that processing compilation errors even results in no effect. In the case of calling an external routine, compilation errors could be sometimes avoided by “#pragma acc routine”. However, most of the calls to an external routine is a library call. Even when the call is included in the GPU processing, the call becomes a bottleneck and good performance will not be achieved. As the for statements are processed for trial one by one, no compilation error occurs in connection with nesting. In the case of intermediate exiting with a break statement or the like, as the parallel processing requires the number of loop iterations be fixed, the program needs to be modified. In the case of presence of data dependency, the parallel processing is in the first place impossible.

Assume that the number of loop statements that do not cause an error even when processed in parallel is A, the gene length is A. The application code is mapped to a gene with length A in such a manner that a gene element with a value of 1 corresponds to presence of a parallel processing directive and a gene element with a value of 0 corresponds to absence of a parallel processing directive.

Next, gene sequences as many as the specified number of individuals are prepared as initial values. Values of genes are generated by randomly allocating 0's and 1's as described with reference to FIG. 4. According to the provided gene sequences, when the value of a gene is 1, directives that designates GPU processing: ¥#pragma acc kernels, ¥#pragma acc parallel loop, and ¥#pragma acc parallel loop vector are inserted in the C/C++ code. Single loops and the like are not parallelized because PGI Compiler provides better performance with ‘kernels’ for the same processing. At this stage, in a code segment corresponding to a certain gene, a part to be processed by the GPU is determined.

The C/C++ code into which the parallel processing directives and data transfer directives are inserted is compiled by PGI compiler on a machine equipped with a GPU. The compiled execution file is deployed and the performance of the execution file is measured using a benchmark testing tool.

For all the individuals, after benchmark performance measurement is performed, a degree of fitness is set for each gene sequence based on its benchmark processing time. Based on the set degree of fitness, individuals to be left are selected. The selected individuals are subjected to the GA processing of crossover, mutation, and faithful copy processes, to generate a group of individuals of the next generation.

For the next-generation individuals, insertion of directives, compilation, performance measurement, setting of degree of fitness, selection, crossover, and mutation processes are performed. When a gene that has a pattern identical to a former pattern is generated in the GA processing, the compilation and performance measurement are not performed for the individual and the same measurement value as before is used.

After the GA process has been completed for a specified number of generations, the C/C++ code in which directives have been added and which corresponds to the gene sequence with the highest performance is selected as the solution.

In the above-described processes, the number of individuals, the number of generations, the crossover rate, the mutation rate, setting of the degree of fitness, and the selection method are parameters of the GA and are specified separately. The proposed technique automates the above-described processes to enable automation of GPU offloading, which conventionally requires time and skill of specialized engineers.

FIGS. 10A and 10B are flowcharts for explaining an overview of operation of the implementation described above. FIG. 10A and FIG. 10B are connected through a connector.

The following processing is performed using an OpenACC compiler designed for C/C++.

### <Code Analysis>

In step S101, the application code analysis section 112 (see FIG. 2) analyzes the code of the C/C++ application.

### <Identification of Loop Statements>

In step S102, the parallel processing designation section 114 (see FIG. 2) identifies loop statements and reference relationships in the C/C++ application.

### <Parallelizability of Loop Statements>

In step S103, the parallel processing designation section 114 checks each loop statement to determine whether the loop statement can be processed on the GPU (#pragma acc kernels).

### <Repetitions Over Loop Statements>

The control section (automatic offloading function section) 11 repeats the processes from step S105 to step S116 between the beginning of the loop at step S104 and the end of the loop at step S117 as many times as the number of the loop statements.

### <Repetitions as Many Times as the Number of Loops (1)>

The control section (automatic offloading function section) 11 repeats the process from step S106 to step S107 between the beginning of the loop in step S105 and the end of the loop in step S108 as many times as the number of loop statements.

In step S106, the parallel processing designation section 114 designates GPU processing (#pragma acc kernels) in accordance with OpenACC for each loop statement and perform compilation.

When an error occurs, in step S107, the parallel processing designation section 114 checks whether GPU processing is feasible, using the next directive (#pragma acc parallel loop).

### <Repetitions as Many Times as the Number of Loops (2)>

The control section (automatic offloading function section) 11 repeats the processes from step S110 to step S111 between the beginning of the loop at step S109 and the end of the loop at step S112 as many times as the number of the loop statements.

In step S110, the parallel processing designation section 114 designates GPU processing (#pragma acc parallel loop) in accordance with OpenACC for each loop statement and perform compilation.

When an error occurs, the parallel processing designation section 114 checks, in step S111, the next directive to determine whether or not GPU processing can be performed (#pragma acc parallel loop vector).

### <Repetitions as Many Times as the Number of Loops (3)>

The control section (automatic offloading function section) 11 repeats the processes from step S114 to step S115 between the beginning of the loop at step S113 and the end of the loop at step S116 as many times as the number of the loop statements.

In step S114, the parallel processing designation section 114 designates GPU processing (#pragma acc parallel loop vector) in accordance with OpenACC for each loop statement and perform compilation.

In Step S115, the parallel processing designation section 114 removes the GPU processing directive from the loop statement when an error occurs.

### <Count the Number of for Statements>

In step S118, the parallel processing designation section 114 counts the number of for statements at which no compilation error occurs and uses the number as the gene length.

### <Provide as Many Patterns as the Specified Number of Individuals>

Next, the parallel processing designation section 114 provides, as initial values, as many gene sequences as the specified number of individuals. Here, the gene sequences are generated by randomly assigning 0's and 1's.

In step S119, the parallel processing designation section 114 prepares as many patterns as the specified number of individuals by mapping the C/C++ application code to the genes.

According to the prepared gene sequences, a directive that specifies parallel processing is inserted in the C/C++ code when the value of a gene is 1 (see #pragma directive in FIG. 4, for example).

The control section (automatic offloading function section) 11 repeats the processes from step S121 to step S128 between the beginning of the loop at step S120 and the end of the loop at step S129 as many times as the specified number of generations.

Further, in the repetitions as many times as the specified number of generations, the processes from step S122 to step S125 are repeated between the beginning of the loop at step S121 and the end of the loop at step S126 as many times as the specified number of individuals. In other words, the repetitions as many times as the specified number of individuals are performed in a nested manner in the iterations as many times as the specified number of generations.

### <Designation of Data Transfer>

In step S122, the data transfer designation section 113 specifies, on the basis of reference relationships between variables, data transfer designation using explicit directive line (#pragma acc data copy/copyin/copyout/present and #pragma acc declarecreate, #pragma acc update).

### <Compilation>

In step S123, the parallel processing pattern generation section 115 (see FIG. 2) compiles the C/C++ code in which directives are specified according to the gene pattern, using PGI Compiler. Specifically, the parallel processing pattern generation section 115 compiles the generated C/C++ code using PGI compiler on a verification machine 14 equipped with a GPU.

Here, a compilation error can occur for example when a plurality of nested for statements are designated for parallelization. Such a case is handled in the same way as a timeout of processing time during performance measurement.

In step S124, the performance measurement section 116 (see FIG. 2) deploys the execution file to the verification machine 14 equipped with a CPU and a GPU.

In step S125, the performance measurement section 116 executes the deployed execution file (binary file) and measures benchmark performance obtained when offloading is performed.

Here, the measurement is not performed on a gene in an intermediate generation that has the same pattern as a gene in a former generation and the same value is used. In other words, when a gene that has a pattern identical to a former pattern is generated in the GA processing, the compilation and performance measurement are not performed for the individual and the same measurement value as before is used.

In step S127, the execution file generation section 117 (see FIG. 2) evaluates individuals in such a manner that an individual that results in a shorter processing time is given a higher degrees of fitness, and selects high-performance individuals.

In step S128, the execution file generation section 117 performs crossover and mutation processes on the selected individuals to generate next-generation individuals. The execution file generation section 117 performs compilation, performance measurement, setting of degree of fitness, selection, crossover, and mutation processes on the next-generation individuals.

Specifically, for all the individuals, after benchmark performance measurement is performed, a degree of fitness is set for each gene sequence based on its benchmark processing time. In accordance with the set degree of fitness, individuals to be left are selected. The execution file generation section 117 performs GA processing of crossover, mutation, and faithful copy processes on the selected individuals to generate a group of individuals of the next generation.

In step S130, after the completion of the GA processing of a specified number of generations, the execution file generation section 117 selects C/C++ code that corresponds to the highest-performance gene sequence (highest-performance parallel processing pattern) as the solution.

### <Parameters of GA>

The number of individuals, the number of generations, the crossover rate, the mutation rate, setting of the degree of fitness, and the selection method described above are parameters of GA. The parameters of the GA may be set as follows, for example.

For example, parameters and conditions of Simple GA performed may be set as follows.
Gene length: The number of parallelizable loop statements
Number of individuals M: A number less than or equal to the gene length
Number of generations T: A number less than or equal to the gene length
Degree of fitness: (Processing time)^{(-1/2)}

With these settings, the shorter the benchmark processing time, the higher the degree of fitness will become. Further, by setting the degree of fitness to processing time raised to the minus one-half power, it is possible to prevent a situation such that an excessively high degree of fitness is given to a certain individual whose processing time is short and thus the search range is narrowed. Further, when the performance measurement does not end within a certain period of time, the measurement is timed out and the degree of fitness is calculated by assuming that the processing time is 1000 seconds or so (a long time). The timeout time may be varied according to performance measurement characteristics.
Selection: Roulette-wheel selection

However, elite preservation, in which a gene with the highest degree of fitness in a generation is preserved in the next generation without being subjected to crossover and mutation processes, is also performed.
Crossover rate Pc: 0.9
Mutation rate Pm: 0.05

### <Cost Performance>

A description will be given of the cost performance of the automatic offloading function.

Consulting the prices of the hardware of GPU boards such as NVIDIA Tesla, the price of a machine equipped with a GPU is about twice the price of a normal machine equipped with a CPU only. However, in general, regarding the cost of a data center or the like, the cost of hardware and system development is equal to or less than one-third of the total cost; the electricity bills and the operating cost of maintenance and operation systems, over one-third; and other costs such as service orders, about one-third. The present embodiment is capable of increasing the performance of time-consuming processing, e.g., cryptographic processing and/or image processing, of an application to be improved by a factor of two or more. Consequently, even when the price of the server hardware doubles, the cost effect can be fully expected.

According to the present embodiment, applications requiring a large execution time due to a large number of loop iterations are identified in advance using gcov and/or gprof or the like and the offloading is executed for trial. With this, applications that can be accelerated can be identified effectively.

### <Time Until Starting Using Actual Service>

A description will be given of the time until starting using the actual service. On the assumption that the time taken for one cycle of compilation to performance measurement is about three minutes for each time, it will take about 20 hours at most for a GA with 20 individuals and 20 generations to search for a solution, but it will take less than eight hours because the compilation and measurement of the same gene patterns as before are omitted. In many cloud, hosting, and network services, it takes about half a day to start using the service. The present embodiment is capable of performing automatic offloading within half a day for example. Assuming that the automatic offloading is finished within half a day and that the user can use the service for trial at the beginning, it is expected that user satisfaction will be sufficiently improved.

It is conceivable to use a plurality of verification machines as many as the number of the individuals to measure performance in parallel, in order to find the areas to be offloaded in a shorter period of time. Controlling the timeout time according to the application may also lead to the reduction of the time. For example, if the offloaded processing takes twice the time for the processing by CPU, the offloaded processing may be regarded as having timed out. In addition, the higher the number of individuals and the number of generations, the higher the possibility of finding a high-performance solution. However, setting these parameters to the maximum requires performing the compilation and performance benchmark testing for the number resulted in multiplying the number of individuals by the number of generations. It will take a longer time until starting the real service. In the case of the present embodiment, a relatively small numbers of individuals and generations are used compared to normal GA. However, by employing a crossover rate Pc of as high as 0.9, it is possible to find a solution with a certain performance in an early time.

### [Extension of Directive Clauses]

In the present embodiment, directives are extended in order to increase the number of applications to which the embodiment can be applied. Specifically, directives for specifying GPU processing are extended to the ‘parallel loop’ directive and the ‘parallel loop vector’ directive in addition to the ‘kernels’ directive.

According to the OpenACC standard, ‘kernels’ is used for single loops and tightly nested loops. parallel loop′ is used for loops including non-tightly nested loops. parallel loop vector′ is used for loops that cannot be parallelized but vectorized. Here, a tightly nested loop is a simple nested loop nested such that when two loops that increment i and j are nested, processing using i and j is performed in the lower-level loop and not in the upper loop. According to the implementation of PGI Compiler and the like, there is a difference between ‘kernels’ and ‘parallel” in that for ‘kernels’, the compiler determines whether to parallelize, whereas for ‘parallel’, a programmer determines whether to parallelize. It should be noted that in the case of Non-Patent Literature 2, the scope of application is narrow because Non-Patent Literature 2 addresses simple loops and does not address loop statements, such as non-tightly nested loops and loops that cannot be parallelized, that cause an error with ‘kernels’.

In view of this, according to the present embodiment, ‘kernels’ is used for single and tightly nested loops and ‘parallel loop’ is used for non-tightly nested loops. In addition, ‘parallel loop vector’ is used for loops that cannot be parallelized but can be vectorized.

Here, the use of the parallel directives can lead to lower reliability of results than when using ‘kernels’. However, it is assumed that sample testing of a final offload program is performed, differences in results from results of processing on a CPU are checked, and the results of the check are presented to a user for confirmation. As CPUs and GPUs differ from each other in terms of hardware in the first place, they differ in the number of significant digits, rounding errors, and the like. For this reason, there is a need of checking the differences from the results obtained using the CPU even when using ‘kernels’ alone.

The [automatic offload operation (before start of operation)] has been described above. The automatic offload operation (before start of operation) is summarized as follows.
Steps S11 and S12 in FIG. 3: Analysis of code
Steps S21 to S23 in FIG. 3: Extraction of offloadable portion
Steps S31 to S32 in FIG. 3: Search for appropriate portion to be offloaded
Step S41 in FIG. 3: Adjustment of resource amount
Step S51 in FIG. 3: Adjustment of deployment place
Steps S61 to S63 in FIG. 3: Deployment of execution file and verification of operation

Steps S11 to S63 described above are code conversion, resource amount adjustment, deployment place adjustment, and verification, which are necessary before the start of the operation of the application.

[Automatic Offload Operation (after Start of Operation)]

Next, the behavior of each section for the automatic offload operation (after the start of the operation) will be described with reference to step numbers in FIG. 3 described above.

As described above, the offload server 1 executes reconfiguration after starting the operation of the GPU logic.

In the reconfiguration after the start of the operation, after the start of the operation of the application, the use characteristics and the like are analyzed and necessary reconfiguration is performed. The target of the reconfiguration is code conversion, adjustment of the resource amount, and adjustment of the deployment place, similarly to before the start of the operation.

### <Basic Policy for GPU Reconfiguration During Operation>

First, a description will be given of a basic policy for GPU reconfiguration during operation.

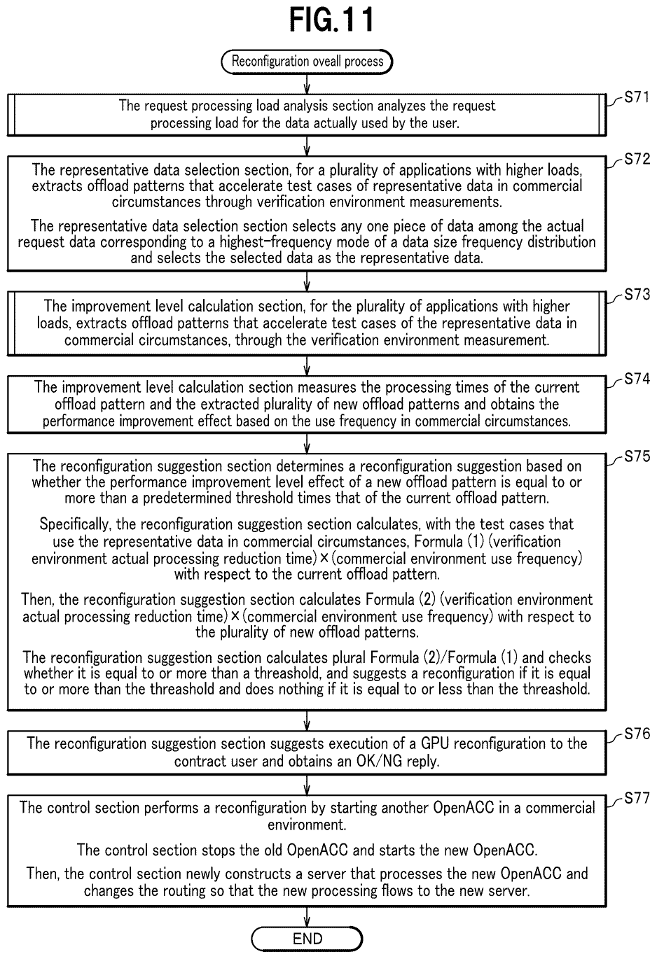

In the approach of FIG. 3 (for details, see the flowchart of below-described FIG. 11), a user-specified application can automatically offload loop statement portions suitable for GPU to a GPU. After offloading to the commercial environment used by the user, the actual performance and price in the commercial environment are checked, and the user starts using the application. However, performance optimization test cases (performance measurement items to be compared between a plurality of offload patterns) use the use data assumed before the start of the operation, specified by the user, and may be greatly deviated from the data actually used after the start of operation.

In view of this, hereinafter, we consider reconfiguring the GPU logic in a case where the use case after the start of operation is different from the first assumption such that the performance is improved by offloading another logic to an FPGA, while reducing the influence to the user. The reconfiguration may be a change to different loop statement offloading even for the same application, or may be a change to offloading for a different application.

There are two reconfigurations of GPU, i.e., dynamic reconfiguration and static reconfiguration. The dynamic reconfiguration is a technique of changing a circuit configuration while running the GPU, in which case the interruption time for rewriting is on the order of ms. On the other hand, the static reconfiguration is a technique of changing a circuit configuration after stopping the GPU, in which case the interruption time is about 1 second. Regarding which one of the dynamic reconfiguration method and the static reconfiguration method is to be employed, it is conceivable to select a reconfiguration method provided by a vendor that manufactures the GPU based on the degree of influence to the user caused by the interruption time. However, as the interruption time occurs in both methods and the rewriting to another logic requires an operation check test, the reconfiguration should not be performed frequently. Thus it is conceivable to set a restriction such that the reconfiguration is suggested only when the effect is equal to or more than a threshold.

Reconfiguration to be considered begins with an analysis of request trends over a certain period (for example, one month or the like). The request trends are analyzed to determine whether there is a request whose processing load is higher than or equal to that of the currently offloaded application. Next, an optimization trial of GPU offloading is performed with a request with a high processing load in the verification environment (FIG. 3) using data actually used commercially (data actually used by the user) instead of the assumed use data.

Determination is made as to whether the new offload pattern found by the verification has a sufficiently higher improvement effect than the current offload pattern based on whether a calculation result of the processing time and the use frequency is more than a threshold. In a case where the calculation result of the processing time and the use frequency exceeds the threshold, a reconfiguration is suggested to the user. After an approval of the user, the commercial environment is reconfigured so as to reduce the influence to the user as much as possible. In a case where the calculation result of the processing time and the use frequency is equal to or less than the threshold, no reconfiguration is suggested to the user.

<Flowchart Illustrating Reconfiguration after Start of Operation>

FIG. 11 is a flowchart illustrating reconfiguration by the offload server 1 after the start of the operation. This is an example applied to GPU reconfiguration.

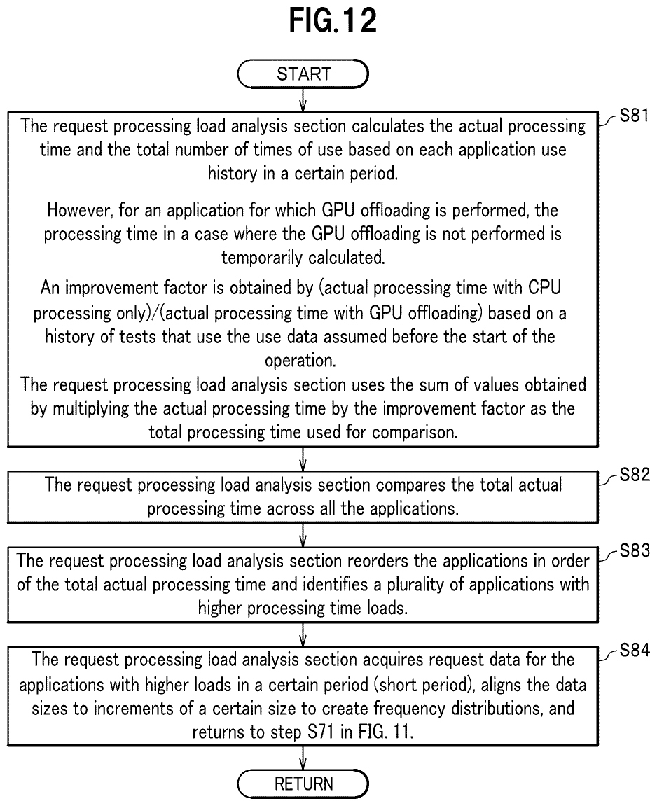

In step S71, the request processing load analysis section 120 analyzes the request processing load for the data actually used by the user. Note that a detailed flow of the commercial request data history analysis processing will be described later with reference to FIG. 12.

In step S72, the representative data selection section 121, for a plurality of applications with higher loads, extracts offload patterns that accelerate test cases of representative data in commercial circumstances through verification environment measurements. Specifically, the representative data selection section 121 selects any one piece of data among the actual request data corresponding to a highest-frequency mode of a data size frequency distribution, analyzed by the request processing load analysis section 120, and selects the selected data as the representative data.

In steps S71 to S72, applications with higher loads are selected.

In step S73, the improvement level calculation section 122, for the plurality of applications with higher loads, extracts offload patterns that accelerate test cases of the representative data in commercial circumstances, through the verification environment measurement.

Specifically, in step S73, the improvement level calculation section 122, based on the representative data selected by the representative data selection section 121, determines a new offload pattern (a new offload pattern found in the verification environment) by executing: the application code analysis section 112; the parallel processing designation section 114; the parallel processing pattern generation section 115; the performance measurement section 116; and the execution file generation section 117, and compares the processing time and the use frequency of the determined new offload pattern with the processing time and the use frequency of the current offload pattern to calculate the performance improvement effect.

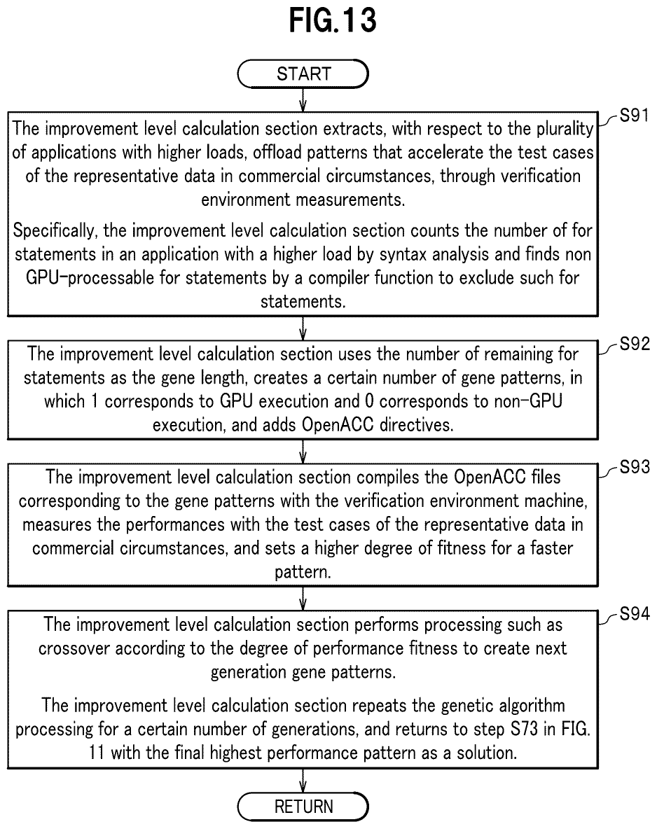

That is, the improvement level calculation section 122 measures the processing times for the current offload pattern and the extracted plurality of new offload patterns, and obtains the performance improvement effect based on the use frequency in commercial circumstances. Specifically the improvement level calculation section 122 calculates, with the test cases that use the representative data in commercial circumstances, Formula (1) (verification environment actual processing reduction time)× (commercial environment use frequency) in the case of the current offload pattern. Then, the improvement level calculation section 122 calculates Formula (2) (verification environment actual processing reduction time)×(commercial environment use frequency) in the cases of the plurality of new offload patterns. Note that a detailed flow of the representative data in commercial circumstances extraction processing will be described later with reference to FIG. 13.

As described above, in step S73, for an application for which GPU offloading is performed, the improvement factor is multiplied to calculate the case where the application is not offloaded, to make a correction to get the case where only the CPU processing is performed, to perform a comparison. In selection of representative data, as there are cases where the average of the data size may be greatly different from the actual use data, the highest-frequency mode of the data size is used.

In step S74, the improvement level calculation section 122 measures the processing times of the current offload pattern and the extracted plurality of new offload patterns and obtains the performance improvement effect based on the use frequency in commercial circumstances.

In step S75, the reconfiguration suggestion section 123 determines a reconfiguration suggestion based on whether the performance improvement level effect of a new offload pattern is equal to or more than a predetermined threshold times that of the current offload pattern. Specifically, the reconfiguration suggestion section 123 checks whether “calculation result of Formula (2)/calculation result of Formula (1)”, calculated by the improvement level calculation section 122, is equal to or more than the predetermined threshold, if “calculation result of Formula (2)/calculation result of Formula (1)” is equal to or more than the predetermined threshold, the reconfiguration suggestion section 123 suggests reconfiguration, and if “calculation result of Formula (2)/calculation result of Formula (1)” is less than the predetermined threshold, the reconfiguration suggestion section 123 does nothing (does not suggest reconfiguration).

In step S76, the reconfiguration suggestion section 123 suggests execution of a GPU reconfiguration to the contract user and obtains from the contract user an OK/NG response regarding the execution of the GPU reconfiguration.

In step S77, the control section 11 performs reconfiguration by starting another OpenACC in a commercial environment, and terminates the processing of this flow. Specifically, the control section 11 stops the old OpenACC and starts the new OpenACC. Then, the control section 11 newly constructs a server that processes the new OpenACC, and changes the routing so that the new process flows to the new server.

FIG. 12 is a detailed flowchart of the commercial request data history analysis processing, and is a subroutine of step S71 in FIG. 11.

When called via a subroutine call in step S71 in FIG. 11, in step S81, the request processing load analysis section 120 calculates the actual processing time and the total number of times of use based on each application use history in a certain period (long time; for example, one month or the like). However, for an application for which GPU offloading is performed, the processing time in a case where the GPU offloading is not performed is temporarily calculated. The improvement factor is obtained by (actual processing time with CPU processing only)/(actual processing time with GPU offloading) based on a history of tests that use the use data assumed before the start of the operation. The request processing load analysis section 120 uses the sum of values obtained by multiplying the actual processing time by the improvement factor as the total processing time used for comparison.

In step S82, the request processing load analysis section 120 compares the total actual processing time across all the applications.

In step S83, the request processing load analysis section 120 reorders the applications in order of the total actual processing time and identifies a plurality of applications with higher processing time loads.

In step S84, the request processing load analysis section 120 acquires request data for the applications with higher loads in a certain period (short period; 12 hours, or the like), aligns the data sizes to increments of a certain size to create frequency distributions, and returns to step S71 in FIG. 11.

FIG. 13 is a detailed flowchart of the improvement level calculation processing, and is a subroutine of step S73 in FIG. 11.

When called by a subroutine call in step S73 in FIG. 11, in step S91, the improvement level calculation section 122 extracts, with respect to the plurality of applications with higher loads, offload patterns that accelerate the test cases of the representative data in commercial circumstances, through verification environment measurements. Specifically, the improvement level calculation section 122 counts the number of for statements in an application with a higher load by syntax analysis and finds non GPU-processable for statements by a compiler function to exclude such for statements.

In step S92, the improvement level calculation section 122 uses the number of remaining for statements as the gene length, creates a certain number of gene patterns, in which 1 corresponds to GPU execution and 0 corresponds to non-GPU execution, and adds OpenACC directives.

In step S93, the improvement level calculation section 122 compiles the OpenACC files corresponding to the gene patterns with the verification environment machine, measures the performances with test cases of the representative data in commercial circumstances, and sets a higher degree of fitness for a faster pattern.

In step S94, the improvement level calculation section 122 performs processing such as crossover according to the degree of performance fitness to create next generation gene patterns. The improvement level calculation section repeats the genetic algorithm processing for a certain number of generations, and returns to step S73 in FIG. 11 with the final highest performance pattern as a solution.

### SUPPLEMENTARY TO IMPLEMENTATION

Implementation will be supplementarily described.

In the implementation, before the start of operation, GPU offloading is performed in the same operation as the previous implementation tool (Non-Patent Literature 3).

For the reconfiguration during operation (“during operation” is a form of “after start of operation”), the implementation is made so that the processing steps of the flowchart illustrating the reconfiguration after the start of operation in FIGS. 11 to 13 are sequentially performed.

Hereinafter, decisions and the like at the time of implementation will be described while supplementing the flows of FIGS. 11 to 13.

First, in the load analysis in step S71 in FIG. 11 described above, request data for a certain period (long period) is analyzed to identify applications with higher loads, and actual request data for the applications is acquired in the certain period (short period).

Here, as the number of applications with higher loads and the certain periods can be freely set by the operator, there is a degree of freedom. However, the above-described long period is assumed to be a long span of one month or more. Furthermore, the above-described short period is assumed to be a short span such as 12 hours. In the request data analysis, the actual processing time and the number of times of use of the application are summed up, and are acquired by the time command of Linux (registered trademark). As the actual elapsed time of an application appears in the log of the time command, a value to be obtained is calculated based on the number of logs and the total time.

### Before Start of Operation

In the representative data selection (before the start of operation) in step S72 of FIG. 11 described above, the actual request data for an application with a higher load in a certain period (short period) is aligned to increments of a certain size to create a frequency distribution. At this time, the number of classes of the frequency distribution is determined by the Sturges' rule. The Sturges' rule is a rule such that, when the number of times of use of the application is n (n is a natural number), it is appropriate to set the number of classes to 1+log₂ n. In order to use the Sturges' rule, it is necessary to determine the number of classes, select the modal class, and then select one piece of representative data from the modal class. In addition, when selecting the representative data, data with a data size closest to the median value of the class is selected as the representative data.

### After Start of Operation

In the representative data selection (after the start of operation) in step S72 of FIG. 11 described above, GPU offloading is executed for the applications with higher loads in the same process as before the start of the operation using the selected representative data. The test cases used for performance measurement differ from the test cases before the start of operation in that representative data in commercial circumstances is used instead of use data assumed.

In the improvement level calculation in step S73 in FIG. 11 described above, it is necessary to observe the improvement effect obtained when the commercial environment is reconfigured with the new offload patterns. As the reconfiguration has not yet suggested to the user, verification must be performed with the verification environment server. However, the improvement level calculation section 122 measures the improvement in one time processing using the representative data in commercial circumstances and calculates the overall improvement level using the use frequency in commercial circumstances. Then, in the calculation of improvement level in step S74 in FIG. 11, a comparison is made as to how much the effect is when the commercial environment is reconfigured.

In the suggestion of reconfiguration in step S75 in FIG. 11 described above, the reconfiguration suggestion section 123 does not suggest a reconfiguration to the user in a case where “the calculation result of Formula (2)/the calculation result of Formula (1)” is less than the predetermined threshold. As it is inconvenient for the user if the reconfiguration suggestion frequently occurs, by setting the threshold of the effect improvement to a value sufficiently larger than one time, it is possible to reduce the frequent occurrence of the reconfiguration suggestion and leave a case where a reconfiguration is truly effective. The threshold of reconfiguration is an implementation that can be variably set, and for example, 1.5 is set.

In the suggestion of reconfiguration in step S76 of FIG. 11 described above, the reconfiguration suggestion section 123 suggests the reconfiguration to the user with information on a price change or an improvement effect. The information on the price change or the improvement effect is information on the price that changes by reconfiguration or how many times the improvement effect in the verification environment has been even when there is no price change. As a result, the contract user can determine whether it is better to perform reconfiguration.

In the execution of reconfiguration in step S77 in FIG. 11 described above, the control section 11, in the GPU processing machine (offload server 1), stops OpenACC before reconfiguration and starts OpenACC after reconfiguration to perform reconfiguration. As it is necessary to perform stopping and starting of OpenACC, an interruption time of about 1 second occurs. If it is desired to further reduce the interruption time, another machine (another server) that processes OpenACC after reconfiguration may be newly started, and the new request may be routed to the new machine. In the method of newly starting another machine, GPU resources are used twice, but the addition of the resources is temporary between before and after switching.

The automatic offload operation (after the start of operation) has been described above.

### Implementation Example

An implementation example will be described.

The following <implementation usage tool> is used to confirm the effectiveness of GPU reconfiguration.

The target application is a C/C++ language application, and as the GPU, NVIDIA Tesla T4*2 is used.

The machine to perform compilation is Supermicro SYS-1029GP-TR (CPU: Intel Xeon Silver 4210R, RAM: 128 GB).

For the GPU processing, PGI compiler 19.10 and CUDA toolkit 10.1 are used. PGI compiler is a compiler that interprets OpenACC for C/C++/Fortran languages. PGI compiler generates and executes bytecode for GPU by specifying OpenACC directive ¥#pragma acc kernels, ¥#pragma acc parallel loop, or the like for a loop statement such as a for statement. PGI compiler enables GPU offloading by generating and executing bytecode for GPU. In addition, PGI compiler is able to instruct an explicit data transfer and to indicate that data transfer is unnecessary, by a directive such as ¥#pragma acc data copyin/copyout/copy and ¥#pragma acc data present.

For syntax analysis of C/C++ language, a syntax analysis library of LLVM/Clang 6.0 (python binding of libClang) is used.

Regarding GPU offloading, for statements for which GPU processing is not possible are found with a function of PGI compiler and excluded from GA. Here, a loop with a small number of loop iterations (for example, 1,000 times or less) is highly likely to be less effective and thus the gene length may be shortened by excluding the loop. It is possible to use profiler gcov to analyze the number of loop iterations.

### Hardware Configuration

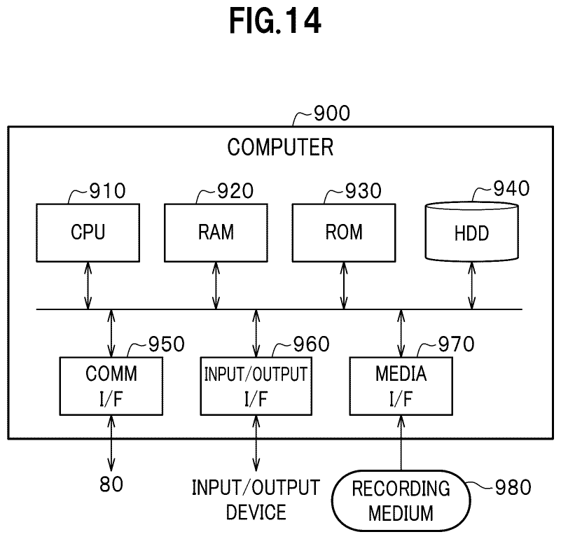

The offload server 1 according to the present embodiment is embodied by, for example, a computer 900 having a configuration as illustrated in FIG. 14. Note that the verification machine 14 illustrated in FIG. 2 is outside the offload server 1.

FIG. 14 is a hardware configuration diagram illustrating an example of computer 900 that embodies the functions of offload server 1.

Computer 900 includes a CPU 910, a RAM 920, a ROM 930, an HDD 940, a communication interface (I/F: Interface) 950, an input/output interface (I/F) 960, and a media interface (I/F) 970.

CPU 910 operates and performs control of each portion according to a program stored in ROM 930 or HDD 940. ROM 930 stores a boot program to be executed by CPU 910 when computer 900 starts up, a program that relies on the hardware of computer 900, and the like.

HDD 940 stores programs to be executed by CPU 910, data to be used by the programs, and the like. Communication interface 950 receives data from another device via a communication network 80, sends the received data to CPU 910, and transmits data generated by CPU 910 to another device via communication network 80.

CPU 910 controls an output device such as a display or a printer and an input device such as a keyboard or a mouse via input/output interface 960. CPU 910 receives data from the input device via input/output interface 960. Also, CPU 910 outputs generated data to the output device via input/output interface 960.

Media interface 970 reads a program or data stored in a recording medium 980 and provides the read program or data to CPU 910 via RAM 920. CPU 910 loads the program from recording medium 980 onto RAM 920 via media interface 970 and executes the loaded program. Recording medium 980 is, for example, an optical recording medium such as a DVD (Digital Versatile Disc) or PD (Phase change rewritable Disk), a magneto-optical recording medium such as an MO (Magneto Optical disk), a tape medium, a magnetic recording medium, a semiconductor memory, or the like.

For example, if computer 900 functions as an offload server 1 according to the present embodiment, CPU 910 of computer 900 embodies the function of each portion of offload server 1 by executing the program loaded on RAM 920. Also, HDD 940 stores the data in each portion of offload server 1. CPU 910 of computer 900 reads these programs from recording medium 980 and executes them, but in another example, these programs may be received from another device via communication network 80.

### EFFECTS

As described above, an offload server 1 according to the present embodiment is an offload server that offloads specific processing of an application specific processing to a GPU, the offload server including: a request processing load analysis section 120 that analyzes a request processing load due to the current offload pattern with respect to data used by a user; a representative data selection section 121 that identifies an application whose processing load is analyzed as high by the request processing load analysis section 120 and selects representative data from request data at a time of use of the application; an improvement level calculation section 122 that creates a new offload pattern (a new offload pattern found in a verification environment) based on the representative data selected by the representative data selection section 121 and calculates a performance improvement effect by comparing a processing time and a use frequency of the created new offload pattern with a processing time and a use frequency of the current offload pattern; and a reconfiguration suggestion section 123 that suggests a GPU reconfiguration when the performance improvement effect is equal to or more than a predetermined threshold.

With this configuration, the offload server 1 reconfigures the GPU logic to a more appropriate GPU logic according to the use characteristics not only before the start of operation but also after the start of operation, so that it is possible to improve the efficiency of resource use in a GPU or the like in which the resource amount is limited.

Specifically, as the offload server 1 is able to reconfigure the GPU logic in response to a change or the like in the use characteristics after the start of operation of the application, the offload server 1 is able to reconfigure the GPU logic with a low influence to the user in a case where there is a possibility that the GPU logic largely deviates from the data actually used after the start of the operation, for example, in a case where the use case after the start of the operation is different from the initial assumption and performance will be improved by offloading another logic to the GPU.

Note that the GPU reconfiguration may be performed such that the loop statements to be offloaded are changed in the same application or that the application for which offloading is to be performed is changed to another application. There are many items to be reconfigured, including a GPU, an FPGA offload logic, a resource amount, and a deployment place.

The cost when the present embodiment is applied will be considered. A GPU board such as NVIDIA Tesla (registered trademark) costs about 200,000 yen per one board. Therefore, when looking only at the hardware price, the price of a machine equipped with a GPU is usually twice the price of a machine with CPU only. However, even if the hardware price itself is doubled, the present technology of improving performance of loop statement processing, which has been time-consuming due to CPU processing, by three times or more and performing reconfiguration to a more appropriate logic is evaluated as cost-effective.

The offload server 1 according to the present embodiment includes: an application code analysis section 112 that analyzes source code of an application; a data transfer designation section 113 that analyzes reference relationships of variables used in loop statements in the application and makes, for data that can be transferred outside a loop, data transfer designation using an explicit directive that explicitly specifies a data transfer outside the loop; a parallel processing designation section 114 that identifies loop statements in the application, and, for each of the identified loop statements, specifies a statement designating parallel processing by an accelerator and perform compilation; a parallel processing pattern generation section 115 that excludes, from loop statements to be offloaded, any iteration statement at which a compilation error occurs and generates a plurality of parallel processing patterns each of which specifies whether to perform parallel processing for each of the loop statements at which no compilation error occurs; a performance measurement section 116 that, for each of the plurality of parallel processing patterns, compiles the application according to the parallel processing pattern, deploys the compiled application to an accelerator verification device, and performs processing for a measurement of a performance obtained when offloading the compiled application to the GPU according to the parallel processing pattern; and an execution file generation section 117 that selects a parallel processing pattern with a highest processing performance from the plurality of parallel processing patterns based on a result of the performance measurement by the processing for the measurement of the performance and compiles the application according to the parallel processing pattern with the highest processing performance to generate an execution file, wherein the improvement level calculation section 122 determines a new offload pattern by executing the application code analysis section 112, the parallel processing designation section 114, the parallel processing pattern generation section 115, the performance measurement section 116, and the execution file generation section 117 based on the representative data selected by the representative data selection section 121 and calculates a performance improvement effect by comparing a processing time and a use frequency of the determined new offload pattern with a processing time and a use frequency of the current offload pattern.

With this configuration, the improvement level calculation section 122 of the offload server 1, based on the representative data, executes the application code analysis section 112, the parallel processing designation section 114, the parallel processing pattern generation section 115, the performance measurement section 116, and the execution file generation section 117 to reconfigure a new offload pattern into a more appropriate GPU logic based on the use characteristics after the start of operation, so that it is possible to improve the efficiency of resource use in the GPU or the like in which the resource amount is limited.

In the offload server 1 according to the present embodiment, the request processing load analysis section 120 obtains an improvement factor by (actual processing time in the case of CPU processing only)/(actual processing time in the case where GPU offloading is performed) according to a history of tests that use the use data assumed before the start of operation, and uses a sum of values obtained by multiplying the actual processing times by the improvement factor as a total processing time used for comparison.

In this manner, when selecting an application with a higher load, the offload server 1, by multiplying the data for the case where the application is GPU-offloaded by the improvement factor, can calculate data for a case where the application is not GPU-offloaded, to make a comparison using the data which has been corrected for a case of CPU processing only. As the data for a case where the offload is not performed is corrected by multiplying the improvement factor, a more accurate actual processing time can be calculated.

In the offload server 1 according to the present embodiment, the request processing load analysis section 120 acquires request data of an application with a higher load in a predetermined period and aligns data sizes to increments of a certain size to create a frequency distribution, and the representative data selection section 121 selects any one piece of data among actual request data corresponding to a highest-frequency mode of the frequency distribution and selects the data as the representative data.

In this manner, when selecting the representative data, although the offload server 1 may possibly select data that greatly differs from the actual use data if selecting the average of the data size, the offload server 1 can select more appropriate representative data by using the highest-frequency mode of the data size.

In the offload server 1 according to the present embodiment, the improvement level calculation section 122 measures processing times of the current offload pattern and a plurality of new offload patterns and calculates a performance improvement effect based on a use frequency in commercial circumstances according to (verification environment actual processing reduction time)× (commercial environment use frequency).

In this manner, the offload server 1 calculates (verification environment actual processing reduction time)× (commercial environment use frequency) with respect to a plurality of new offload patterns, calculates (verification environment actual processing reduction time)×(commercial environment use frequency) with respect to the current offload pattern, and divides the former by the latter to obtain a more accurate performance improvement level effect using two parameters of the processing time and the use frequency.

The offload server 1 according to the present embodiment includes: another server that processes OpenACC after GPU reconfiguration; and a control section 11 that, when executing GPU reconfiguration, stops the OpenACC before reconfiguration, newly starts the other server, and switches routing to another server for a new request.

With this configuration, as the control section 11 performs GPU reconfiguration by activating the reconfigured OpenACC in the other server, it is possible to perform stopping and activation of OpenACC without interruption.

The present invention provides an offload program for causing a computer to function as the offload server described above.

With this configuration, the functions of the offload server 1 described above can be implemented using a commonly used computer.

Note that, in the offload server 1 according to the present embodiment, the request processing load analysis section 120 calculates an actual processing time and the total number of times of use from each application use history in a predetermined period. In this manner, the offload server 1 can analyze the request processing load of the data actually used by the user from each application use history in the predetermined period.

Among the processing described in the embodiment, all or some of the processing described as being performed automatically may be performed manually, or all or some of the processing described as being performed manually may be performed automatically using a known method. In addition, information including process procedures, control procedures, specific names, various types of data and parameters described and illustrated in the description and drawings may be changed as appropriate unless otherwise stated.

Further, the components of the devices illustrated in the drawings are functionally conceptual and do not necessarily need to be physically configured as illustrated. In other words, specific form of distribution and integration of the devices are not limited to those illustrated in the drawings and all or some of the devices can be distributed or integrated functionally or physically in any units according to various loads and usages.

Further, some or all of the configurations, functions, processing units, processing means and the like described above may be implemented in hardware by, for example, designing them in integrated circuits. Further, the configurations, functions and the like described above may be implemented in software that causes a processor to interpret and execute a program that implements the functions. The program that implements the functions and information such as tables and files can be held in a recording device such as a memory, a hard disk, or an SSD (Solid State Drive) or a recording medium such as an IC (Integrated Circuit) card, an SD (Secure Digital) card, or an optical disc.

Furthermore, in the present embodiment, any device may be used as long as the GPU processing can be offloaded.

In the description of the present embodiment, for statements are exemplified as iteration statements (loop statements). However, the iteration statements include while statements and do-while statements other than for statements. However, for statements, which specifies the continuation conditions or the like of looping, are more suitable.

### REFERENCE SIGNS LIST

1 Offload server
11 Control section
12 Input/Output section
13 Storage section
14 Verification machine (accelerator verification device)
15 OpenIoT resource
111 Application code designation section
112 Application code analysis section
113 Data transfer designation section
114 Parallel processing designation section
114a Offload area extraction section
114b Intermediate language file output section
115 Parallel processing pattern generation section
116 Performance measurement section
116a Binary file deployment section
117 Execution file generation section
118 Actual environment deployment section
119 Performance measurement test extraction and execution section
120 Request processing load analysis section (processing load analysis section)
121 Representative data selection section
122 improvement level calculation section
123 Reconfiguration suggestion section
124 provision-to-user section
130 Application code
131 Code pattern DB
132 Equipment resource DB
133 Test case DB
134 Intermediate language file
151 Various types of devices
152 CPU-GPU-equipped device
153 CPU-FPGA-equipped device
154 CPU-equipped device

1. An offload server that offloads specific processing of application specific processing to a Graphics Processing Unit (GPU), the offload server comprising:
processing load analysis circuitry configured to analyze a request processing load resulting from processing data used by a user with a current offload pattern;
representative data selection circuitry configured to identify an application whose request processing load is analyzed as high by the processing load analysis circuitry and select representative data from request data at a time of use of the application;
improvement level calculation circuitry configured to create a new offload pattern based on the representative data selected by the representative data selection circuitry and calculate a performance improvement effect by comparing a processing time and a use frequency of the created new offload pattern with a processing time and a use frequency of the current offload pattern; and
reconfiguration suggestion circuitry configured to suggest a GPU reconfiguration when the performance improvement effect is equal to or more than a predetermined threshold.

2. The offload server according to claim 1, further comprising:
application code analysis circuitry configured to analyze source code of an application;
data transfer designation circuitry configured to analyze reference relationships of variables used in loop statements in the application and to make, for data that can be transferred outside a loop, data transfer designation using an explicit directive that explicitly specifies a data transfer outside the loop;
parallel processing designation circuitry configured to identify loop statements in the application, and, for each of the identified loop statements, specify a statement designating parallel processing by the GPU and perform compilation;
parallel processing pattern generation circuitry configured to exclude, from loop statements to be offloaded, any loop statement at which a compilation error occurs and generate a plurality of parallel processing patterns each of which specifies whether to perform parallel processing for each of the loop statements at which no compilation error occurs;
performance measurement circuitry configured to, for each of the plurality of parallel processing patterns, compile the application according to the parallel processing pattern, deploy the compiled application to an accelerator verification device, and perform processing for a measurement of a performance obtained when offloading the compiled application to the GPU according to the parallel processing pattern; and
execution file generation circuitry configured to select a parallel processing pattern with a highest processing performance from the plurality of parallel processing patterns based on a result of the performance measurement by the processing for the measurement of the performance and compile the application according to the parallel processing pattern with the highest processing performance to generate an execution file,
wherein the improvement level calculation circuitry is configured to create the new offload pattern by executing the application code analysis circuitry, the parallel processing designation circuitry, the parallel processing pattern generation circuitry, the performance measurement circuitry, and the execution file generation circuitry based on the representative data selected by the representative data selection circuitry and calculate the performance improvement effect by comparing the processing time and the use frequency of the created new offload pattern with the processing time and the use frequency of the current offload pattern.

3. The offload server according to claim 1,
wherein the processing load analysis circuitry is further configured to obtain an improvement factor by (actual processing time in a case of CPU processing only)/(actual processing time in a case where GPU offloading is performed) according to a history of tests that use use data assumed before start of operation, and to use a sum of values obtained by multiplying actual processing times by the improvement factor for comparison.

4. The offload server according to claim 1,
wherein the processing load analysis circuitry is further configured to acquire request data of an application with a higher load in a predetermined period and align data sizes of the request data to increments of a certain size to create a frequency distribution, and
wherein the representative data selection circuitry is further configured to select any one piece of data among actual request data corresponding to a highest-frequency mode of the frequency distribution and select the selected one piece of data as the representative data.

5. The offload server according to claim 1,
wherein the improvement level calculation circuitry is configured to measure processing times of the current offload pattern and a plurality of the new offload patterns and calculate the performance improvement effect based on a use frequency in commercial circumstances according to (verification environment actual processing reduction time)×(commercial environment use frequency).

6. The offload server according to claim 1, further comprising:
another server configured to process Open Accelerator (OpenACC) after GPU reconfiguration; and
control circuitry configured to, when executing a GPU reconfiguration, stop an OpenACC before reconfiguration, newly start the another server, and switch routing to the another server for a new request.

7. An offload control method for an offload server that offloads application specific processing to a graphics processing unit (GPU), the method comprising:
analyzing a request processing load resulting from processing data used by a user with a current offload pattern;
identifying an application for which the analyzed request processing load is high and selecting representative data from request data at a time of use of the application;
creating a new offload pattern based on the selected representative data and calculating a performance improvement effect by comparing a processing time and a use frequency of the created new offload pattern with a processing time and a use frequency of the current offload pattern; and
suggesting a GPU reconfiguration when the performance improvement effect is equal to or more than a predetermined threshold.

8. A non-transitory computer-readable medium storing a computer program that, when executed by a computer, causes the computer to perform the method of claim 7.
